(19) United States
(12) Patent Application Publication
(10) Pub. No.: US 2026/0051005 A1
(43) Pub. Date: Feb. 19, 2026

(54) ARTIFICIAL INTELLIGENCE-BASED SYSTEM FOR GENERATING A PATENT SPECIFICATION AND METHOD THEREOF

(71) Applicant: Anand Kumar Biswas, Bangalore (IN)

(72) Inventors: Anand Kumar Biswas, Bangalore (IN); Vidya Bhaskar Singh Nandiyal, Prayagraj (IN); Amit Mendiratta, Delhi (IN); Gurdev Singh Parmar, Bengaluru (IN); Abhishek Ashish, Sahibganj (IN); N S Bharath, Puttur (IN); Lara Biswas, Bangalore (IN)

(21) Appl. No.: 19/299,433

(22) Filed: Aug. 14, 2025

Related U.S. Application Data
(60) Provisional application No. 63/683,728, filed on Aug. 16, 2024.

(51) Int. Cl. G06Q 50/18; G06F 16/41; G06F 16/432; G06F 40/106; G06F 40/166

(52) U.S. Cl. CPC G06Q 50/184; G06F 16/41; G06F 16/432; G06F 40/106; G06F 40/166

(57) ABSTRACT

An artificial intelligence-based system and method for generating a patent specification are disclosed. The artificial intelligence-based system integrates a plurality of subsystems, including project management, multi-modal data acquisition, data extraction, data chunking, refined disclosure generation, illustration preparation, figure description generation, claim generation, and specification orchestration. The artificial intelligence-based system obtain multi-modal data, such as invention disclosures, and prior art references, is parsed into structured data chunks stored. A plurality of domain-specific generative AI agents retrieve and process relevant data chunks to iteratively produce refined invention disclosures, claims, and specification sections in jurisdiction-specific templates. The artificial intelligence-based system supports automated figure extraction, line drawing conversion, and contextual figure description mapping. Real-time preview, prompt-driven refinement, and amendment propagation ensure internal consistency between the claims, figures, and descriptions. The artificial intelligence-based system enhances accuracy, compliance, and efficiency in patent specification generation, eliminating manual integration between technical, legal, and illustrative content.

### CROSS REFERENCE TO RELATED APPLICATION(S)

This application claims the priority to and incorporates by reference the entire disclosure of U.S. provisional patent application bearing No. 63/683,728 filed on Aug. 16, 2024”.

### TECHNICAL FIELD

Embodiments of the present disclosure relate to intellectual property management and particularly relate to an artificial intelligence-based system and method for generating a patent specification and a method thereof to automate drafting, editing, and management of the patent specification.

### BACKGROUND

A process of generating patent specifications remains a labor-intensive, domain-sensitive, and expertise-driven task that requires significant manual effort. Traditionally, patent practitioners depend heavily on structured interviews, iterative document exchanges, and manual extraction of information from invention disclosures, prior art references, test results, and related technical documentation. This fragmented and subjective workflow often leads to inconsistencies in terminology, formatting, and structural presentation across various sections of a patent specification.

Existing systems and tools offer limited support in automating or streamlining the end-to-end patent drafting workflow. Most current platforms focus narrowly on document storage or claim formatting without offering intelligent assistance for core content generation, such as preparing refined invention disclosures, figure descriptions, or specification sections. Further, these tools often lack integration with advanced artificial intelligence frameworks capable of contextualizing multi-modal data, including visual, textual, and structured information provided by inventors or engineering teams.

In technical domains involving chemical structures, biological sequences, or device schematics, conventional systems struggle to process specialized data formats such as Simplified Molecular Input Line Entry System (SMILES), International Chemical Identifier (InChl), molecular (MOL) files, or image-based prototypes. The inability to extract, normalize, and interpret such domain-specific information results in incomplete or non-compliant specifications, particularly when drafting for multiple jurisdictions with varying legal and formatting requirements.

Moreover, there exists a pronounced gap in dynamically adapting patent content to domain-specific language conventions, disclosure styles, and prior art context. While large language models and generative AI systems have shown promise in general text generation, their direct application to patent drafting remains constrained due to a lack of fine-tuning on technical disclosure datasets and legal drafting standards.

In the existing technology, several tools and system solutions are developed to assist in the preparation of patent specification documents. These tools and system solutions typically offer functionalities such as template-based drafting, automated formatting, and basic text editing. However, they often fall short in addressing a full spectrum of challenges, as they primarily focus on improving efficiency rather than enhancing the overall quality and accuracy of the patent specification documents.

In the existing technology, tools for producing patent specification are available. The such tools are configured to perform basic steps such as inputting a title, selecting the type of invention, entering the graphic interface, inputting the name and function of each element to form an output data section, inputting the data having multiple sets of text areas, cooperating the input data having multiple sets of text areas with individual output data section, combining, trans-pasting and composing the corresponding input description to form multiple sets of output data sections. However, such tools require extensive manual data entry at multiple stages, including inputting titles, types of inventions, and detailed reference numerals for each element names and functions. The said tools involve a sequential approach, which is a cumbersome and slow, especially when dealing with complex inventions that require detailed descriptions and numerous elements. The sequential approach has another limitation as it does not have capability of making changes in corresponding previous section of document based on an addition or modification done in a later section of the document.

There are various technical problems with the generation of patent specification documents in the prior art. In the existing technology, several tools offer only partial automation, requiring substantial manual input and oversight. The tools and system solutions often lack advanced features to fully automate the drafting of complex sections like claims and detailed descriptions. Existing solutions are inefficient at integrating domain-specific knowledge and expertise, which is crucial for accurately representing the technical aspects of an invention. Existing systems do not scale well to handle large volumes of patent applications or adapt to the diverse requirements of different technical fields and jurisdictions.

Therefore, there is a need for an artificial intelligence-based system to address the aforementioned issues by automating the preparation of patent specification documents, enhancing the quality, and reducing the overall cost and time associated with the manual preparation of the patent specification documents.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, an artificial intelligence-based system for generating a patent specification is disclosed. The artificial intelligence-based system comprises one or more hardware processors and a memory unit. The memory unit is operatively connected to the one or more hardware processors, the memory unit comprises a set of computer-readable instructions in form of a plurality of subsystems, configured to be executed by the one or more hardware processors. The plurality of subsystems comprises a project management subsystem, a data obtaining subsystem, a data-extracting subsystem, a data-chunking subsystem, a refined disclosure generating subsystem, an illustrations preparation subsystem, a figure description generating subsystem, a patent claims generating subsystem, a specification-generating subsystem, and a specification orchestrating subsystem.

In an aspect, the project management subsystem is configured with one or more computer-implemented tools to create one or more projects by obtaining metadata comprising at least one of: a project name, a unique identification number, and project domain information, from one or more users through a user interface. The one or more computer-implemented tools comprise at least one of: a project creation tool, a docketing tool, a document management tool, a timeline management tool, and a jurisdiction selection tool. The project management subsystem is configured to select at least one domain-specific generative artificial intelligence agent from a plurality of domain-specific generative artificial intelligence agents based on the project domain information. The plurality of domain-specific generative artificial intelligence agents are trained on at least one of: historical patent documents, a plurality of examination reports, historical technical literatures, historical standards documents, historical product manuals, and historical scholarly publications, associated with a corresponding technical domain. The plurality of domain-specific generative artificial intelligence agents are fine-tuned on at least one of: diverse disclosure styles, terminologies, and structural conventions unique to diverse domains.

In other aspects, the data obtaining subsystem is configured to obtain multi-modal data of an associated project within the one or more projects from at least one of: one or more cloud storage services and one or more end devices. The multi-modal data comprises at least one of: invention disclosures, non-patent literatures, presentation decks, design prototypes, test results, performance logs, illustration sketches, chemical structure representations, biological sequence data, formulation datasets, and prior art references. The multi-modal data is provided in at least one of: textual formats, image-based formats, audio formats, video formats, structured data file (SDF) formats, presentation formats, molecular (MOL) file format, simplified molecular input line entry system (SMILES) formats, and international chemical identifier (InChl) formats.

In yet another aspect, the data-extracting subsystem is configured to extract at least one of: textual data, audio data, visual data, and contextual metadata, from the multi-modal data using one or more format-specific parsers. The data-extracting subsystem is further configured to detect each file in the multi-modal data based on at least one of: file extensions, multipurpose internet mail extensions (MIME type), and content-based sniffing. The data-extracting subsystem is further configured to route each file in the multi-modal data to an associated format-specific parser within the one or more format-specific parsers to extract raw information. The data-extracting subsystem is further configured to extract at least one of: the textual data, the audio data, the visual data, and the contextual metadata, associated with the raw information using the one or more format-specific parsers. The one or more format-specific parsers comprise at least one of: one or more natural language parsers, one or more optical character recognition (OCR) parsers, one or more audio-to-text transcription modules, one or more image parsers, one or more chemical structure parsers, one or more video parsers, one or more metadata extractors, and one or more domain-specific structured data parsers. The data-extracting subsystem is further configured to normalize at least one of: the textual data, the audio data, the visual data, and the contextual metadata, by at least one of: strip out boilerplate language, disclaimers, eliminate scanned watermark overlays, and fix encoding issues.

In other aspects, the data-chunking subsystem is configured to generate a plurality of data chunks from at least one of: the extracted textual data, the extracted audio data, the extracted visual data, and the extracted contextual metadata, using at least one of: one or more artificial intelligence frameworks, one or more rule-based logics, and one or more heuristic procedures. The data-chunking subsystem is configured to store the plurality of data chunks in a vector database using embedding-based indexing procedures.

In yet another aspect, the refined disclosure generating subsystem is configured with a plurality of pre-defined sections comprising a plurality of queries. Each query of the plurality of queries characterizes as a plurality of prompts for one or more artificial intelligence models to generate a fine-tuned response, by retrieving applicable data chunks within the plurality of data chunks from the vector database for generating a refined invention disclosure. The refined disclosure generating subsystem is further configured to provide one or more clickable elements to generate the plurality of queries to add to the refined invention disclosure. The refined disclosure generating subsystem is further configured to provide the fine-tuned response to each query of the plurality of queries using the one or more artificial intelligence models by retrieving the applicable data chunks. The refined disclosure generating subsystem is further configured to generate one or more clarifying queries based on detected indistinctness in at least one of: the multi-modal data, the plurality of data chunks, and the fine-tuned response associated with each query of the plurality of queries. The refined disclosure generating subsystem is further configured to generate the fine-tuned response to each clarifying query of the one or more clarifying queries by processing the applicable data chunks within the plurality of data chunks using at least one of: Teoriya Resheniya Izobretatelskikh Zadatch (TRIZ) principles, semantic similarity procedures, contextual co-occurrence procedures, and dependency mapping procedures. The refined disclosure generating subsystem is further configured to compile the plurality of queries and the one or more clarifying queries with associated fine-tuned responses into a structured disclosure output as the refined invention disclosure.

In other aspects, the illustrations preparation subsystem is configured to at least one of: extract one or more figures from the multi-modal data, obtain prepared illustration data from at least one of: the one or more cloud storage services and the one or more end devices, generate the one or more figures based on the refined invention disclosure, and provide a figure-editor tool for generating the one or more figures. The illustrations preparation subsystem is configured with the one or more optical character recognition (OCR) parsers to extract the one or more figures from the multi-modal data. The illustrations preparation subsystem further comprises a generative image model configured to convert the one or more figures in one of: hand drawn figures, photographic figures, and computer-aided design (CAD)-based three-dimensional figures into line drawings conforming to jurisdictional guidelines for format of the one or more figures.

In yet another aspect, the figure description generating subsystem is configured to generate description associated with the one or more figures by mapping at least one of: the plurality of data chunks and the refined invention disclosure, with at least one of: one or more label numbers and one or more label names, extracted from each figure of the one or more figures. The figure description generating subsystem is configured to: a) perform one of: optical extraction and semantic extraction of at least one of: the one or more label numbers and the one or more label names from each figure of the one or more figures using at least one of: one or more image recognition models and natural language processing models, b) contextually map the one or more label names with corresponding one or more labelled elements in the refined invention disclosure and the plurality of data chunks by using at least one of: relation extraction models, visual-textual alignment models, embedding similarity computation procedures, and named entity recognition (NER) procedures, and c) generate the description associated with the one or more figures comprising at least one of: structural identification, functional role, spatial relationship, and interconnection of the one or more labelled elements.

In other aspects, the patent claims generating subsystem configured to generate one or more claims in a user selected claim templet within one or more predefined claim templates, based on analyzing at least one of: one or more prior art data chunks in the plurality of data chunks, the description associated with the one or more figures, and the refined invention disclosure, using at least one of: the one or more artificial intelligence models and one or more user defined prompts. The patent claims generating subsystem is configured to classify the user-selected claim template as one of: a method claim, a system claim, a product claim, and a process claim. The patent claims generating subsystem is configured to extract claimable subject matter from at least one of: the refined invention disclosure, the description associated with the one or more figures, and the one or more prior art data chunks, using the one or more artificial intelligence models comprising at least one of: a) one or more natural language processing models for semantic parsing, b) one or more comparative analysis models to distinguish novel features from the one or more prior art data chunks, c) dependency parsing to determine logical relationships between technical features in the plurality of data chunks, and d) a rule-based claims logic prompts for constructing preamble, transitional phrases, and body elements. The patent claims generating subsystem is configured to generate the one or more claims comprising: an independent claim and one or more dependent claims. The patent claims generating subsystem is configured to validate the one or more claims against predefined jurisdiction-specific claim drafting rules, including at least one of: number of claims, unity of an invention, and dependency constraints.

In yet another aspect, the specification-generating subsystem configured with a plurality of specification sections. The plurality of specification sections comprising at least one of: a title section, a cross-references section, a technical field section, a background section, objectives of the invention section, a summary of the invention section, a brief description of the drawings, a detailed description section, an abstract, and one or more optional jurisdiction-defined sections. The plurality of specification sections characterizes as the plurality of prompts for the one or more artificial intelligence models to generate specification responses, by retrieving information at least one of: the applicable data chunks from the plurality of data chunks, the refined invention disclosure, the description associated with the one or more figures, and the generated one or more claims, using at least one of: the NER procedures, relation extraction procedures, dependency parsing procedures, and action mapping procedures. The specification generating subsystem is configured to maintain internal consistency across the plurality of specification sections by validating that each claim of the one or more claims is supported in the generated specification responses, and each figure of the one or more figures is aligned with the description associated with the one or more figures and related specification sections.

In one aspect, the patent claims generating subsystem and the specification generating subsystem are configured with the plurality of domain-specific generative artificial intelligence agents. The plurality of domain-specific generative artificial intelligence agents are trained on the plurality of examination reports using supervised learning procedures, configured to adapt claim phrasing, claim structure, claim dependency relationships, and generate the specification responses for the plurality of specification sections, based on frequently encountered objections in the plurality of examination reports.

In another aspect, the specification generating subsystem further comprises a specification validation module. The specification validation module is configured to analyze each specification section of the plurality of specification sections with the generated specification responses to check compliance and consistency with at least one of: terminology associated with the one or more claims, formatting rules, language guidelines, and enablement requirements. The specification validation module is configured to analyze each specification section of the plurality of specification sections based on the jurisdictional guidelines, using at least one of: the NER procedures, a jurisdiction rules validator configured with regex patterns, one or more large language models (LLMs) trained on legal drafting datasets.

In other aspect of the present disclosure, the specification orchestrating subsystem is configured to orchestrate the specification responses and the one or more claims in a user-selected jurisdiction template within the one or more jurisdiction templates based on at least one of: jurisdiction-specific legal formatting rules, section ordering protocols, phrasing requirements, and specification section mappings for generating the patent specification.

Yet another aspect of the present disclosure, at least one of: the refined disclosure generating subsystem, the illustrations preparation subsystem, the figure description generating subsystem, the patent claims generating subsystem, the specification generating subsystem, is configured with a prompt receiving module, a data inserting module, and a preview interface module. The prompt receiving module is configured to receive at least one of: the plurality of prompts and the one or more user defined prompts, in at least one of: a generative artificial intelligence environment, and a conversation artificial intelligence environment, for one of: generating the patent specification in user defined instructions, regenerating the generated patent specification, and elaborating the generated patent specification.

The data inserting module is configured to allow the one or more users to insert at least one of: the one or more figures, one or more tables, one or more special characters, one or more chemical structures, and one or more mathematical expressions, in the patent specification. The preview interface module is configured to display the generated patent specification in real time alongside at least one of: a refined invention disclosure workspace, a claim generating workspace, and a specification generating workspace, to provide section-wise navigation for reviewing the generated patent specification.

In another aspect, the plurality of subsystems further comprises a data amendment subsystem. The data amendment subsystem is configured to receive one or more user amendments made in at least one: the one or more claims, one specification section of the plurality of specification sections, and one labelled element of the one or more labelled elements. The data amendment subsystem is configured to detect at least one of: semantic impact and structural impact of the one or more user amendments on at least one of: unamended claims of the one or more claims, unamended specification section of the plurality of specification sections within the patent specification. The data amendment subsystem is configured to update corresponding patent specification with the received one or more user amendments based on detected at least one of: the semantic impact and the structural impact to maintain internal consistency of terminology, scope, and dependencies.

In accordance with another embodiment of the present disclosure, an artificial intelligence-based method for generating the patent specification is disclosed. In the first step, the artificial intelligence-based method includes creating, by the one or more hardware processors through the project management subsystem, the one or more projects by obtaining the metadata comprising at least one of: the project name, the unique identification number, and the project domain information, from the one or more users through the user interface.

In the next step, the artificial intelligence-based method includes obtaining, by the one or more hardware processors through the data obtaining subsystem, the multi-modal data of the associated project within the one or more projects from at least one of: the one or more cloud storage services and the one or more end devices.

In the next step, the artificial intelligence-based method includes extracting, by the one or more hardware processors through the data-extracting subsystem, at least one of: the textual data, the audio data, the visual data, and the contextual metadata, from the multi-modal data using the one or more format-specific parsers.

In the next step, the artificial intelligence-based method includes generating, by the one or more hardware processors through the data-chunking subsystem, the plurality of data chunks from at least one of: the extracted textual data, the extracted audio data, the extracted visual data, and the extracted contextual metadata, using at least one of: the one or more artificial intelligence frameworks, the one or more rule-based logics, and the one or more heuristic procedures.

In the next step, the artificial intelligence-based method includes storing, by the one or more hardware processors through the data-chunking subsystem, the plurality of data chunks in the vector database using the embedding-based indexing procedures.

In the next step, the artificial intelligence-based method includes generating, by the one or more hardware processors through the refined disclosure generating subsystem, the refined invention disclosure using the plurality of pre-defined sections comprising the plurality of queries, each query of the plurality of queries characterizes as the plurality of prompts for the one or more artificial intelligence models to generate the fine-tuned response by retrieving applicable data chunks of the plurality of data chunks from the vector database.

In the next step, the artificial intelligence-based method includes preparing, by the one or more hardware processors through the illustrations preparation subsystem, the one or more figures by at least one of: extracting the one or more figures from the multi-modal data, obtaining prepared illustration data from at least one of: the one or more cloud storage services and the one or more end devices, generating the one or more figures based on the refined invention disclosure, and providing the figure-editor tool for generating the one or more figures.

In the next step, the artificial intelligence-based method includes generating, by the one or more hardware processors through a figure description generating subsystem, the description associated with the one or more figures by mapping at least one of: the plurality of data chunks and the refined invention disclosure, with at least one of: one or more label numbers and one or more label names, extracted from each figure of the one or more figures.

In the next step, the artificial intelligence-based method includes generating, by the one or more hardware processors through a patent claims generating subsystem, one or more claims in a user selected claim template within one or more predefined claim templates, based on analyzing at least one of: one or more prior art data chunks in the plurality of data chunks, the description associated with the one or more figures, and the refined invention disclosure, using at least one of: the one or more artificial intelligence models and one or more user defined prompts.

In the next step, the artificial intelligence-based method includes generating, by the one or more hardware processors through the specification generating subsystem, specification responses using the plurality of specification sections, the plurality of specification sections characterizes as the plurality of prompts for the one or more artificial intelligence models to generate the specification responses by retrieving information from at least one of: the applicable data chunks from the plurality of data chunks, the refined invention disclosure, the description associated with the one or more figures, and the generated one or more claims, using at least one of: the NER procedures, the relation extraction procedures, the dependency parsing procedures, and the action mapping procedures.

In the next step, the artificial intelligence-based method includes orchestrating, by the one or more hardware processors through the specification orchestrating subsystem, the specification responses and the one or more claims in the user-selected jurisdiction template within the one or more jurisdiction templates based on at least one of: the jurisdiction-specific legal formatting rules, the section ordering protocols, the phrasing requirements, and the specification section mappings to generate the patent specification.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limited in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 illustrates an exemplary block diagram representation of a network architecture depicting an artificial intelligence-based system for generating a patent specification, in accordance with an embodiment of the present disclosure; and

FIG. 2A illustrates an exemplary block diagram representation of the artificial intelligence-based system as shown in FIG. 1 for generating the patent specification, in accordance with an embodiment of the present disclosure;

FIG. 2B illustrates an exemplary block diagram of a plurality of subsystems connected to at least one of: a prompt receiving module, a data inserting module, and a preview interface module, in accordance with an embodiment of the present disclosure;

FIG. 2C illustrates an exemplary user interface depicting the prompt receiving module, in accordance with an embodiment of the present disclosure;

FIG. 2D illustrates an exemplary user interface depicting the data inserting module, in accordance with an embodiment of the present disclosure;

FIG. 2E illustrates an exemplary user interface depicting the preview interface module, in accordance with an embodiment of the present disclosure; and

FIG. 3 illustrates an exemplary flow chart of an artificial intelligence-based method for generating the patent specification, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module include dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed permanently configured (hardwired) or temporarily configured (programmed) to operate in a certain manner and/or to perform certain operations described herein.

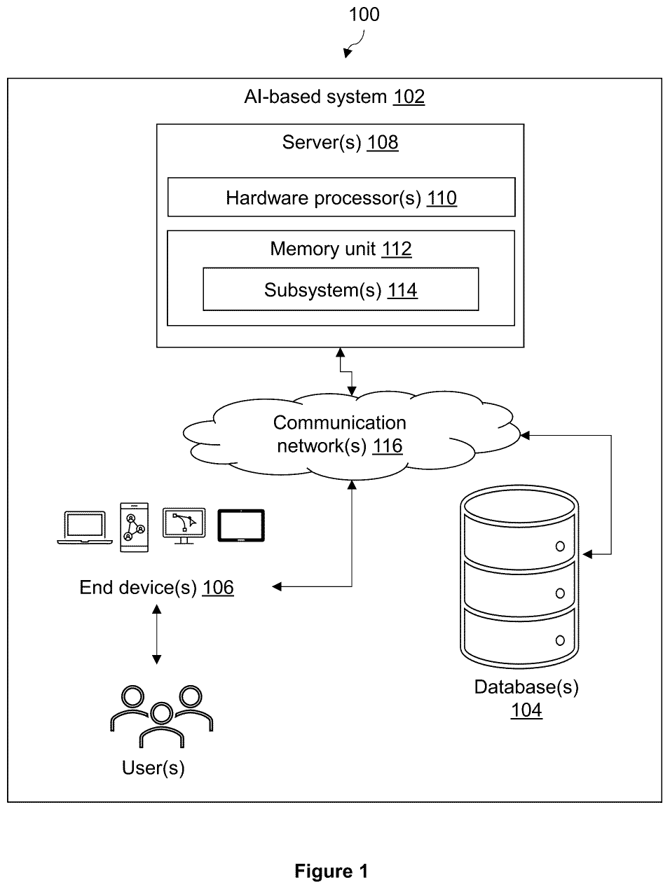

Referring now to the drawings, and more particularly to FIG. 1 through FIG. 3, where similar reference characters denote corresponding features consistently throughout the figures, there are shown preferred embodiments, and these embodiments are described in the context of the following exemplary system and/or method.

FIG. 1 illustrates an exemplary block diagram representation of a network architecture 100 depicting an artificial intelligence-based system 102 for generating a patent specification, in accordance with an embodiment of the present disclosure.

According to an exemplary embodiment of the present disclosure, the network architecture 100 may include the artificial intelligence-based system 102, one or more databases 104, and one or more end devices 106. The artificial intelligence-based system 102 is implemented over a computing environment that comprises, but not limited to, at least one of: one or more servers 108, the one or more end devices 106, one or more edge computing nodes, virtualized computing instances, and cloud-based processing units. The one or more servers 108 may host centralized processing, large-scale storage, and orchestration services for executing the plurality of subsystems, whereas the one or more end devices 106 may enable local data acquisition, preliminary processing, and user interaction. The one or more edge computing nodes may be strategically deployed closer to the data source to reduce latency and enhance real-time performance, while the virtualized computing instances and the cloud-based processing units provide scalable, on-demand computational resources for processing multi-modal data and executing the one or more artificial intelligence models. This distributed computing architecture ensures that the artificial intelligence-based system 102 functions seamlessly across a variety of hardware configurations, network topologies, and deployment scenarios, thereby enabling both centralized and decentralized execution of the artificial intelligence-based patent specification generation workflows.

At least one of: the one or more servers 108, the one or more end devices 106, one or more edge computing nodes, the virtualized computing instances, and the cloud-based processing units, include one or more hardware processors 110 and a memory unit 112, communicatively and operatively coupled to each other via one or more communication networks 116. The memory unit 112 stores one or more executable components in the form of a plurality of subsystems 114, which are configured to perform various artificial intelligence-based operations for generating and orchestrating the patent specifications based on the multi-modal data received from one or more users.

In an exemplary embodiment, the one or more communication networks 116 act as a medium to facilitate real-time data exchange between the one or more end devices 106, the artificial intelligence-based system 102, and the one or more databases 104. The one or more communication networks 116 may be a wired communication network and/or a wireless communication network. The one or more communication networks 116 enable synchronous and asynchronous communication for transmitting multi-modal data, system-generated content, one or more commands, one or more prompts, feedback, and updated outputs. The one or more communication networks 116 also ensures that secure and reliable communication channels are maintained throughout the patent specification generation workflows and orchestration workflows.

In an exemplary embodiment, the one or more communication networks 116 may be, but not limited to, a wired communication network and/or a wireless communication network, a local area network (LAN), a wide area network (WAN), a Wireless Local Area Network (WLAN), a metropolitan area network (MAN), a telephone network, such as the Public Switched Telephone Network (PSTN) or a cellular network, an intranet, the Internet, a fiber optic network, a satellite network, a cloud computing network, a combination of networks, and the like. The wired communication network may comprise, but not limited to, at least one of: Ethernet connections, Fiber Optics, Power Line Communications (PLCs), Serial Communications, Coaxial Cables, Quantum Communication, Advanced Fiber Optics, Hybrid Networks, and the like. The wireless communication network may comprise, but not limited to, at least one of: wireless fidelity (wi-fi), Light Fidelity (LiFi), cellular networks (including fourth generation (4G) technologies and fifth generation (5G) technologies, sixth generation (6G) technologies), Bluetooth®, ZigBee®, long-range wide area network (LoRaWAN), satellite communication, radio frequency identification (RFID), advanced IoT protocols, mesh networks, non-terrestrial networks (NTNs), near field communication (NFC), and the like.

In an exemplary embodiment, the one or more hardware processors 110 communicates with the one or more databases 104 that store structured and unstructured data required for processing, indexing, retrieval, and persistence of the multi-modal project data. The one or more databases 104 may include, but not limited to, storing, and managing data related to various aspects related to operations associated with the artificial intelligence-based system 102, such as, but not limited to, one or more user profiles, a plurality of examination reports, pre-defined instructions, access logs, project data, system configurations, uploaded data, data associated with one or more artificial intelligence models, and the like. The one or more databases 104 may be any kind of database such as, but not limited to, relational databases, non-relational databases, graph databases, document databases, dedicated databases, dynamic databases, monetized databases, scalable databases, cloud databases, distributed databases, any other databases, and a combination thereof. The one or more databases 104 are configured to support the functionality of the artificial intelligence-based system 102 and enables efficient data retrieval and storage for various aspects of the preparation of the patent specification.

In an exemplary embodiment, the one or more end devices 106 may represent various endpoints, such as, but not limited to, user communication devices, computing terminals, mobile devices, smartphones, Personal Digital Assistants (PDAs), tablet computers, phablet computers, wearable computing devices, Virtual Reality/Augmented Reality (VR/AR) devices, laptops, desktops, and the like, which executes a set of program instructions associated with the artificial intelligence-based system 102. The one or more end devices 106 are configured with a user interface configured to enable seamless interaction between the one or more users and the artificial intelligence-based system 102. The user interface may include the graphical user interface (GUI) units, voice-based interfaces, and touch-based interfaces, depending on the capabilities of the artificial intelligence-based system 102 being used. The GUI units may be configured to display outputs, including at least one of: a project creation dashboard for initializing new one or more projects with associated metadata; an interface for uploading and managing the multi-modal data such as textual disclosures, images, chemical structures, or audio recordings; an interactive prompt panel for engaging with generative artificial intelligence models through one of: one or more pre-defined queries and one or more user-defined queries; a visual editor for refining generated patent specification; a drawing workspace for one of: viewing, editing, and generating patent-compliant figures and associated labels; a specification generating workspace for displaying the patent specification in real-time with section-wise navigation; and a feedback module for one of: submitting clarifications, amendments, and confirmations to generated content.

In some implementations, the GUI may also facilitate drag-and-drop support for one of: the multi-modal data, the one or more figures and structured files, and the like. The GUI may also facilitate autosave features, and collaborative access for multiple authorized users within a single project environment. These user interface elements collectively enable the one or more users to iteratively review, refine, and finalize the generated patent specification with increased efficiency, consistency, and legal compliance.

In some implementations the one or more end devices 106 may also support multimodal inputs, allowing the one or more users to interact through at least one of: voice commands, text inputs, and gesture-based controls, ensuring accessibility and ease of use across different user demographics. The one or more end devices 106 are configured to securely transmit and receive data to and from the artificial intelligence-based system 102 via one or more communication networks 116, ensuring seamless user experience and real-time synchronization.

The one or more users may be, but not limited to, one of: inventors, patent professionals, and authorized stakeholders participating in the preparation or review of the patent specification. The one or more users access the artificial intelligence-based system 102 remotely through the one or more end devices 106 to upload data, initiate processing, interact with generation interfaces, and review or amend the generated content.

In an exemplary embodiment, the artificial intelligence-based system 102 may be implemented by way of a single device or a combination of multiple devices that may be operatively connected or networked together. The artificial intelligence-based system 102 may be implemented in hardware or a suitable combination of hardware and software. The memory unit 112 may include the plurality of subsystems 114. The one or more hardware processors 110 are configured to execute machine-readable program instructions for dynamically recommending the course of action sequences for generating and orchestrating the patent specification. Execution of the machine-readable program instructions by the one or more hardware processors 110 may enable the artificial intelligence-based system 102 to dynamically recommend the course of action sequence. The course of action sequences may involve various steps or decisions taken within the artificial intelligence-based system 102 to complete the patent specification generation and orchestration process. This generation process may include steps such as, but not limited to, managing projects, obtaining the multi-modal data, extracting the multi-modal data, generating the refined disclosures, preparing illustrations, generating description associated with the one or more figures, generating claims, generating the plurality of specification sections, and the like, based on disclosed invention and analyses of one or more prior arts.

In an exemplary embodiment, the artificial intelligence-based system 102 may be implemented by way of an application programming interface (API) deployed on the one or more servers 108. The API facilitates the integration and interaction between the artificial intelligence-based system 102 and various client applications and the one or more end devices 106. The implementation via API ensures a modular and scalable architecture, enabling seamless communication, data exchange, and command execution between the artificial intelligence-based system 102 and external entities. The artificial intelligence-based system 102 may be accessed and utilized by the one or more users through a subscription-based model, allowing for flexible and scalable deployment of artificial intelligence capabilities.

In an exemplary embodiment, the one or more hardware processors 110 may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

In an exemplary embodiment, the one or more hardware processors 110 may include, for example, microprocessors, microcomputers, microcontrollers, digital signal processors, central processing units, state machines, logic circuits, and/or any devices that manipulate data or signals based on operational instructions. Among other capabilities, the one or more hardware processors 110 may fetch and execute computer-readable instructions in the memory unit 112 operationally coupled with the artificial intelligence-based system 102 for performing tasks such as data processing, input/output processing, and/or any other functions. Any reference to a task in the present disclosure may refer to an operation being performed or that may be performed on data.

Though few components and the plurality of subsystems 114 are disclosed in FIG. 1, there may be additional components and subsystems which is not shown, such as, but not limited to, ports, routers, repeaters, firewall devices, network devices, the one or more databases 104, network attached storage devices, assets, machinery, instruments, facility equipment, emergency management devices, image capturing devices, any other devices, and combination thereof. The person skilled in the art should not be limiting the components/subsystems shown in FIG. 1. Although FIG. 1 illustrates the artificial intelligence-based system 102, and the one or more end devices 106 connected to the one or more databases 104, one skilled in the art can envision that the artificial intelligence-based system 102, and the one or more end devices 106 may be connected to several user devices and communication devices located at various locations and the one or more databases 104 via the one or more communication network 116.

Those of ordinary skilled in the art will appreciate that the hardware depicted in FIG. 1 may vary for particular implementations. For example, other peripheral devices such as an optical disk drive and the like, local area network (LAN), wide area network (WAN), wireless (e.g., wireless-fidelity (Wi-Fi)) adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the artificial intelligence-based system 102 is unique to the present disclosure or necessary for an understanding of the present disclosure is depicted and described. The remainder of the construction and operation of the artificial intelligence-based system 102 may conform to any of the various current implementations and practices that were known in the art.

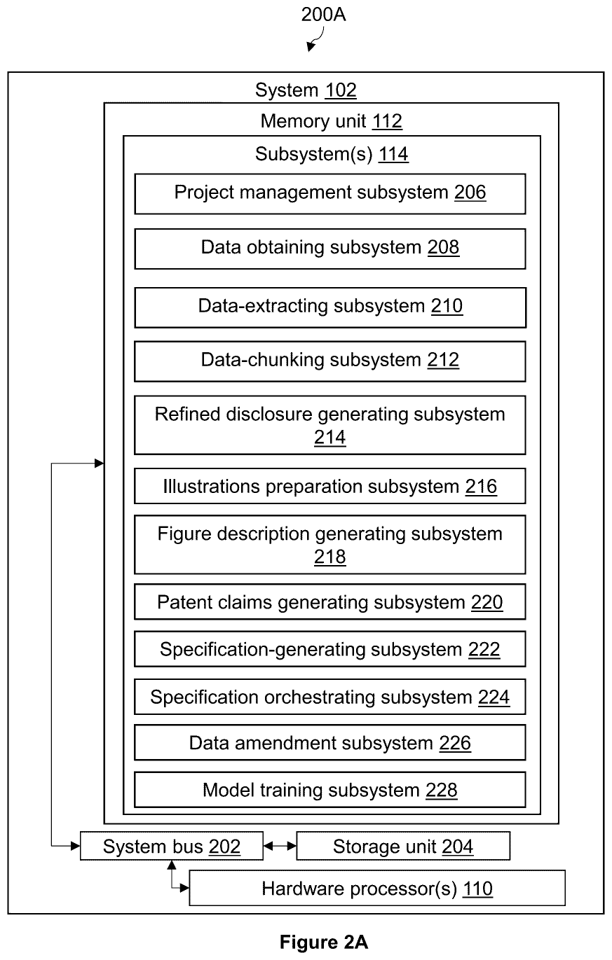

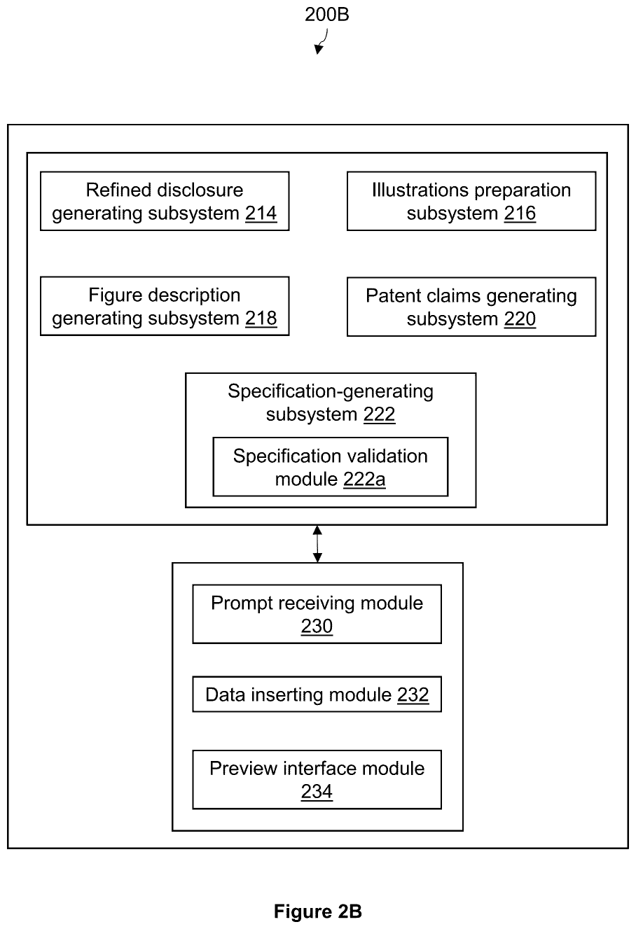

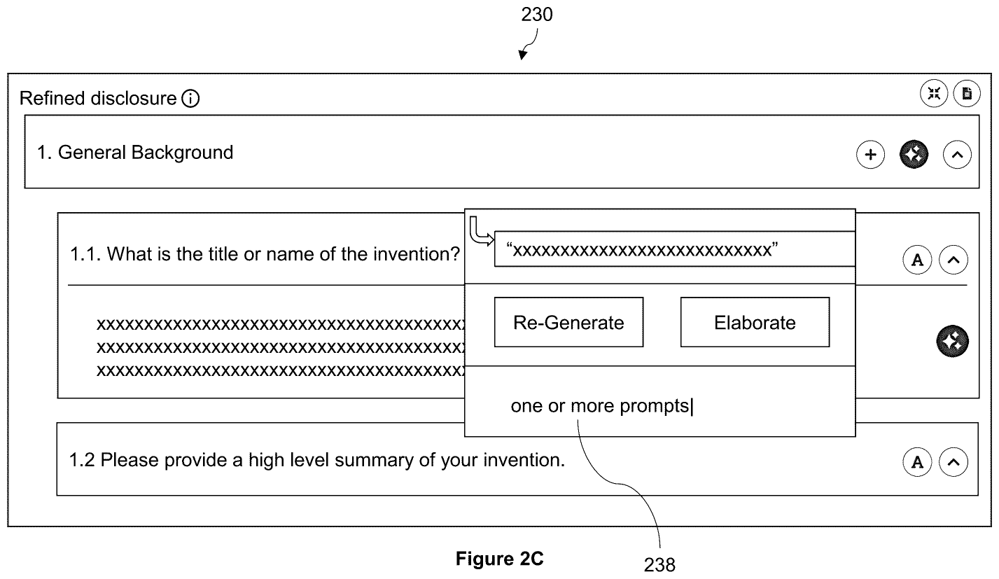

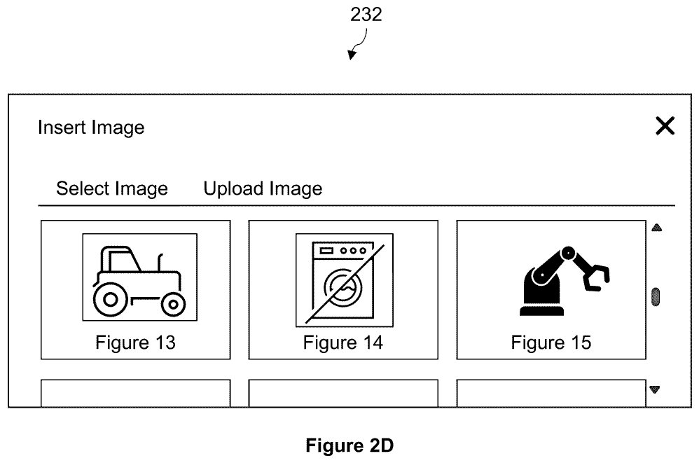

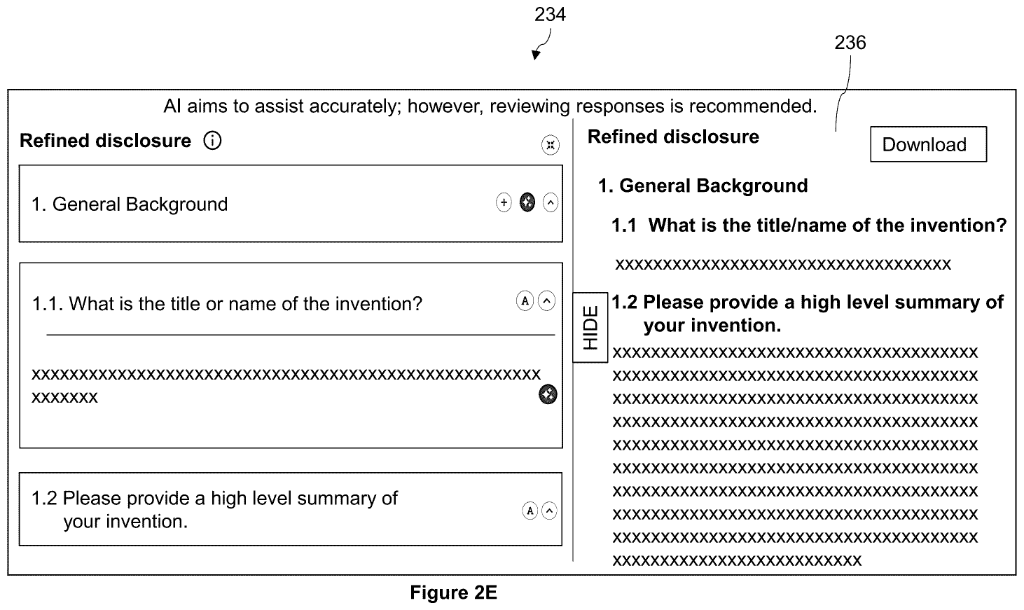

FIG. 2A illustrates an exemplary block diagram representation 200A of the artificial intelligence-based system 102 as shown in FIG. 1 for generating the patent specification, in accordance with an embodiment of the present disclosure.

FIG. 2B illustrates an exemplary block diagram 200B of the plurality of subsystems 114 connected to at least one of: a prompt receiving module 230, a data inserting module 232, and a preview interface module 234, in accordance with an embodiment of the present disclosure.

FIG. 2C illustrates an exemplary user interface depicting the prompt receiving module 230, in accordance with an embodiment of the present disclosure.

FIG. 2D illustrates an exemplary user interface depicting the data inserting module 232, in accordance with an embodiment of the present disclosure.

FIG. 2E illustrates an exemplary user interface depicting the preview interface module 234, in accordance with an embodiment of the present disclosure.

In an exemplary embodiment, the artificial intelligence-based system 102 (hereinafter referred to as the system 102). The system 102 comprises the one or more hardware processors 110, the memory unit 112, and a storage unit 204. The one or more hardware processors 110, the memory unit 112, and the storage unit 204 are communicatively coupled through a system bus 202 or any similar mechanism. The system bus 202 functions as the central conduit for data transfer and communication between the one or more hardware processors 110, the memory unit 112, and the storage unit 204. The system bus 202 facilitates the efficient exchange of information and instructions, enabling the coordinated operation of the system 102. The system bus 202 may be implemented using various technologies, including but not limited to, parallel buses, serial buses, and high-speed data transfer interfaces such as, but not limited to, at least one of a: universal serial bus (USB), peripheral component interconnect express (PCIe), and similar standards.

In an exemplary embodiment, the plurality of subsystems 114 comprises a project management subsystem 206, a data obtaining subsystem 208, a data-extracting subsystem 210, a data-chunking subsystem 212, a refined disclosure generating subsystem 214, an illustrations preparation subsystem 216, a figure description generating subsystem 218, a patent claims generating subsystem 220, a specification-generating subsystem 222, a specification orchestrating subsystem 224, a data amendment subsystem 226, and a model training subsystem 228. The one or more hardware processors 110, as used herein, means any type of computational circuit, such as, but not limited to, a microprocessor unit, the microcontrollers, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 110 may also include embedded controllers, such as generic or programmable logic devices or arrays, application-specific integrated circuits, single-chip computers, and the like.

The memory unit 112 may be a non-transitory volatile memory and a non-volatile memory. The memory unit 112 may be coupled to communicate with the one or more hardware processors 110, such as being a computer-readable storage medium. The one or more hardware processors 110 may execute machine-readable instructions and/or source code stored in the memory unit 112. A variety of machine-readable instructions may be stored in and accessed from the memory unit 112. The memory unit 112 may include any suitable elements for storing data and machine-readable instructions, such as read-only memory, random access memory, erasable programmable read-only memory, electrically erasable programmable read-only memory, a hard drive, a removable media drive for handling compact disks, digital video disks, diskettes, magnetic tape cartridges, memory cards, and the like. In the present embodiment, the memory unit 112 includes the plurality of subsystems 114 stored in the form of machine-readable instructions on any of the above-mentioned storage media and may be in communication with and executed by the one or more hardware processors 110.

The storage unit 204 may be a cloud storage or the one or more databases 104 such as those shown in FIG. 1. The storage unit 204 may store, but not limited to, recommended course of action sequences dynamically generated by the system 102. The course of action sequences may involve various steps or decisions taken within the system 102 to complete the patent specification generation process. This generation process may include steps such as identifying relevant prior art, generating a set of claims, generating detailed descriptions, and formatting the specification in accordance with patent office requirements. Additionally, the storage unit 204 may store, but not limited to, user input data, generated patent specification documents, templates and standard clauses, the one or more artificial intelligence (AI) models, user interaction logs, compliance and validation data, version history, backup data, recovery data, and the like. By storing this comprehensive set of data, the storage unit 204 supports the robust and efficient operation of the system 102, enabling it to dynamically generate the patent specification tailored to the specific needs and inputs of the one or more users. The storage unit 204 may be any kind of database such as, but not limited to, relational databases, dedicated databases, dynamic databases, monetized databases, scalable databases, cloud databases, distributed databases, any other databases, and a combination thereof.

In an exemplary embodiment, the project management subsystem 206 is configured with one or more computer-implemented tools to create one or more projects by obtaining metadata comprising at least one of: a project name, a unique identification number, project domain information, from one or more users through the user interface. The metadata serves as a foundational layer for project tracking, identification, classification, and context initialization, enabling subsequent subsystems to retrieve and operate upon the project-specific data effectively.

In an exemplary embodiment, the one or more computer-implemented tools comprise, but not limited to, at least one of: a project creation tool, a docketing tool, a document management tool, a timeline management tool, a jurisdiction selection tool, and the like. The project creation tool is configured to receive initial project metadata input from the one or more users, assign internal identifiers, and register an associated project within the one or more databases 104. The docketing tool enables tracking of project-associated deadlines, legal filings, office actions, and correspondence history associated with the associated project within the one or more projects. The document management tool facilitates secure upload, storage, and version control of invention disclosures, prior art references, examination reports, and generated patent specification documents. The timeline management tool allows the one or more users to define deliverables, milestone checkpoints, and internal review stages across the patent generation lifecycle. The jurisdiction selection tool enables the one or more users to specify one or more jurisdictions for which the patent specification is to be generated, thereby activating relevant legal formatting templates and compliance checks in downstream subsystems.

The project management subsystem 206 is further configured to select at least one domain-specific generative artificial intelligence (AI) agent from the plurality of domain-specific generative AI agents based on the project domain information. The project domain information may include keywords, classification codes (e.g., International Patent Classification (IPC)/Cooperative Patent Classification (CPC)), technology descriptors, and custom tags input by the one or more users, and is used to determine the technical domain such as, but not limited to, one of: biotechnology, mechanical systems, software engineering, chemical formulations, and the like, applicable to the associated project. Further, the project domain information is configured to assist the one or more users to determine number of projects associated with each domain for purposes of project tracking, resource allocation, workload balancing, domain-specific analytics, and performance assessment across the system 102. The project domain information facilitates informed decision-making by allowing the one or more users to visualize domain-specific concentration, identify underrepresented or overrepresented technical areas, prioritize high-impact innovation domains, and optimize the use of the plurality of domain-specific generative AI agents based on current system load and expertise distribution.

The plurality of domain-specific generative AI agents are pretrained or fine-tuned on domain-relevant corpora comprising at least one of: historical patent documents, a plurality of examination reports, historical technical literatures, historical standards documents, historical product manuals, and historical scholarly publications, associated with a corresponding technical domain. The domain-relevant corpora are structured to provide the one or more domain-specific generative AI agents with contextual grounding, terminology alignment, and knowledge of recurring legal and technical conventions in the specific field.

The plurality of domain-specific generative AI agents are additionally fine-tuned on at least one of: diverse disclosure styles, terminologies, and structural conventions unique to diverse domains. This includes stylistic variations in how disclosures are written, the domain-specific lexicons used (e.g., chemical identifiers, gene sequences, control logic terminology), and the format in which technical specifications are commonly structured in the plurality of specification sections. As a result, the selected domain-specific generative AI agent within the plurality of domain-specific generative AI agents is capable of generating the patent specification, such as claims, specification responses, the descriptions associated with the one or more figures, and refined invention disclosures, that reflect the conventions and expectations of the specified domain, thereby improving quality, readability, and alignment with patent office expectations.

Furthermore, the project management subsystem 206 is configured to provide the one or more computer-implemented tools to define key milestones and timelines for each project, ensuring that all critical steps, such as data ingestion, refined disclosure generation, illustrations preparation, patent claims generation, specification orchestration, internal review, and jurisdictional compliance, are completed in a timely and structured manner. These milestones are associated with automated notifications, progress tracking metrics, and dependency mappings to other subsystems, thereby enabling the one or more users to monitor and control the patent generation workflow efficiently.

In an exemplary embodiment, the data obtaining subsystem 208 is configured to obtain the multi-modal data of the associated project within the one or more projects from at least one of: one or more cloud storage services and the one or more end devices 106. The data obtaining subsystem 208 is configured to operate as a centralized acquisition layer responsible for gathering heterogeneous multi-modal data artifacts relevant to the associated project. The data obtaining subsystem 208 may interface with external cloud repositories (i.e., the one or more cloud storage services) through secured Application Programming Interface (API) connections, including authentication protocols and data retrieval handlers, to programmatically access and download project-specific datasets associated with the multi-modal data or shared by the one or more users. The data obtaining subsystem 208 may also interact directly with at least one of: one or more local end devices and one or more remote end devices, using web-based upload interfaces or secure file transfer modules to receive the multi-modal data for the associated project. The Multi-modal data typically refers to information collected or represented in more than one “mode” or type of data, often from different sources or sensors, that capture different aspects of the same event, object, or phenomenon. Examples of modalities include: Text (documents, transcripts), Images (photographs, scans), Audio (speech, music), Video (combination of image+audio over time), Sensor readings (temperature, GPS coordinates, accelerometer data), and Structured data (tables, spreadsheets, database records).

The multi-modal data comprises at least one of, but not limited to, invention disclosures, non-patent literatures, presentation decks, design prototypes, test results, performance logs, illustration sketches, chemical structure representations, biological sequence data, formulation datasets, prior art references, functional block diagrams, design schematics, data sheets, procedural steps, simulation results, statistical analyses, multimedia presentations, and the like. Each of these categories contributes distinct technical and contextual information that is valuable for generating a comprehensive and accurate patent specification. For example, the invention disclosures may include structured or unstructured descriptions of the inventive concept, experimental methods, and proposed embodiments. The non-patent literatures may consist of at least one of: scientific papers, journal articles, and white papers that provide supporting background or validation. The presentation decks and design prototypes may include slides, annotated diagrams, and visual summaries used in generation of refined invention disclosure or innovation board presentations. The test results and performance logs offer quantitative evidence or experimental data supporting the functionality or advantages of the invention. The illustration sketches provide early-stage concept visuals, while the chemical structure representations, biological sequence data, and formulation datasets contribute domain-specific elements crucial for the inventions in one of: chemical fields, pharmaceutical fields, and biotechnological fields. The prior art references may include, but not limited to, at least one of: known related publications, patents, and utility models previously reviewed by the one or more users, the inventors, and patent practitioners.

The multi-modal data is provided in at least one of: textual formats, image-based formats, audio formats, video formats, structured data file (SDF) formats, presentation formats, molecular (MOL) file format, simplified molecular input line entry system (SMILES) formats, and international chemical identifier (InChl) formats. The textual formats may include, but not limited to, one of: document extensible markup language (DOCX), Portable Document Format (PDF), Text File (TXT), Hypertext Markup Language (HTML) files, and the like, which hold at least one of: core narrative information, tabular information, and the like. The image-based formats encompass at least one of: scanned sketches, photographs, illustrative information, exported diagrams in formats such as, but not limited to, one of: Portable Network Graphics (PNG), Joint Photographic Experts Group (JPEG), Scalable Vector Graphics (SVG), Tagged Image File Format (TIFF), and the like. The audio formats may contain verbal invention descriptions, brainstorming recordings, or inventor interviews, provided as one of: MPEG Audio Layer 3, Waveform Audio File Format, and other encodings. The video formats may include screen recordings, demonstration videos, or recorded experimental setups in one of: moving picture experts group (mpeg)-4, audio video interleave (AVI), and QuickTime Movie (MOV) formats. The SDF formats typically encapsulate chemical structures with metadata and are used in cheminformatics workflows. The presentation formats include files such as one of: PPTX and PDF slide decks. The MOL file format represents detailed atomic connectivity data, while the SMILES and InChl formats provide linear and hashed textual representations of molecular structures, respectively. The diverse range of multi-modal data formats ensures comprehensive flexibility and compatibility with various sources and types of information relevant to generate the patent specification.

In an exemplary embodiment, the data-extracting subsystem 210 is configured to extract at least one of: textual data, audio data, visual data, and contextual metadata, from the multi-modal data using one or more format-specific parsers. The data-extracting subsystem 210 operates as a content interpretation and structuring engine, responsible for decoding and interpreting diverse data types embedded in various file formats submitted as part of the associated project. Upon receipt of the multi-modal data, the data-extracting subsystem 210 is configured to initiate file-level detection and parsing workflows to extract raw information while preserving fidelity and traceability.

The data-extracting subsystem 210 is further configured to detect each file in the multi-modal data based on at least one of, but not limited to, file extensions, multipurpose internet mail extensions (MIME type), content-based sniffing, and the like. The file extensions (e.g., .docx, .jpg, .sdf, .mp4) and MIME types (e.g., application/pdf, image/png, audio/wav, video/mp4) provide conventional metadata about the file structure and content type. However, to ensure robustness and accuracy, the data-extracting subsystem 210 also performs content-based sniffing, which involves inspecting at least one of: binary signatures, header values, and content markers inside the file associated with the multi-modal data to validate or override the externally supplied format information. This hybrid detection mechanism ensures that improperly labeled, renamed, or malformed files are still accurately classified for downstream processing.

Following detection, the data-extracting subsystem 210 is further configured to route each file in the multi-modal data to an associated format-specific parser within the one or more format-specific parsers to extract raw information. This routing is based on the classification outcome and may rely on internal mapping logic that matches detected format types with the corresponding parser modules. The routing process may be executed through a microservice-based architecture or through internal function calls within the system 102, depending on deployment configuration.

The data-extracting subsystem 210 is further configured to extract at least one of: the textual data, the audio data, the visual data, and the contextual metadata, associated with the raw information using the one or more format-specific parsers. The one or more format-specific parsers are configured to interpret and structure the multi-modal data from their native representations into intermediate, machine-readable forms. For example, one or more natural language parsers are used to extract at least one of: sentences, paragraphs, tables, and section headings from text documents. One or more optical character recognition (OCR) parsers are applied to scanned PDFs or image files to extract embedded text and labels to convert into word files. One or more audio-to-text transcription modules are configured to convert speech from inventor meetings or recorded explanations into textual transcripts. Image parsers are configured to extract at least one of: the one or more label numbers and the one or more label names, and layout information from the one or more figures. The one or more chemical structure parsers convert molecular representations in one of: MOL, SDF, SMILES, and InChl formats into symbolic data structures. One or more video parsers may extract one of: keyframes, scene transitions, and transcribed dialogues from recorded demonstrations; one or more metadata extractors analyze file-level and embedded contextual metadata such as authorship, timestamps, titles, and tags. Further, one or more domain-specific structured data parsers are tailored to interpret files with domain-encoded formats, such as experimental logs or biological sequence files.

Once the raw information has been extracted, the data-extracting subsystem 210 is further configured to normalize at least one of: the textual data, the audio data, the visual data, and the contextual metadata, by at least one of, but not limited to, strip out boilerplate language, disclaimers, eliminate scanned watermark overlays, fix encoding issues, and the like. The normalization ensures that the extracted data is clean, coherent, and ready for semantic interpretation. For instance, OCR artifacts, inconsistent encoding (e.g., non-UTF8 characters), and visual overlays such as watermarks or scan lines are removed. Legal disclaimers or repetitive boilerplate text, often included in the multi-modal data, are stripped to avoid contamination of inputs to the one or more AI model. The normalization phase may also include structural alignment (e.g., paragraph detection, table formatting), whitespace trimming, and file reconstruction steps to ensure that each content element maintains semantic integrity before being passed to the data-chunking subsystem 212 or stored in a vector database.

In an exemplary embodiment, the data-chunking subsystem 212 is configured to generate a plurality of data chunks from at least one of: the extracted textual data, the extracted audio data, the extracted visual data, and the extracted contextual metadata, using at least one of, but not limited to, one or more AI frameworks, one or more rule-based logics, one or more heuristic procedures, and the like. The data-chunking subsystem 212 assists as a transformation layer responsible for segmenting large-scale or unstructured content into semantically coherent and computationally manageable units referred to as data chunks. The plurality of data chunks form atomic data units that downstream the one or more AI models use for retrieval, generation, and reasoning tasks involved in constructing the patent specification.

The one or more AI frameworks refer to software platforms, libraries, or toolkits that provide the necessary infrastructure, pre-built components, and development tools to build, train, test, and deploy artificial intelligence models. The data-chunking subsystem 212 applies the one or more AI frameworks, such as, but not limited to, at least one of: one or more transformer-based models, one or more embedding generators, and one or more language segmentation models, to analyze the extracted multi-modal data for thematic or semantic boundaries. The one or more transformer-based models utilize self-attention mechanisms to capture long-range dependencies within the multi-modal data, enabling accurate detection of thematic and semantic boundaries across complex technical content. The one or more embedding generators convert textual, visual, or audio data into dense vector representations, facilitating semantic similarity computations that group related content into coherent and contextually relevant data chunks. The one or more language segmentation models are trained to identify and split content at logical boundaries, such as paragraph breaks, topic shifts, or discourse transitions, by leveraging linguistic patterns and structural cues to ensure precise segmentation for downstream processing.

The one or more AI frameworks are capable of recognizing logical structures such as, but not limited to, at least one of: paragraph breaks, topic shifts, linguistic cues, and discourse transitions. In addition to artificial intelligence-based procedures, the one or more rule-based logics may be employed to segment content according to predetermined patterns. The one or more rule-based logics refer to explicitly programmed, deterministic segmentation rules that operate without relying on probabilistic or machine learning-based inference. The one or more rule-based logics define fixed patterns or conditions, such as the presence of structural markers like section headers, bullet points, and numbered clauses, or formatting cues such as bold text, indentation, and font size, that act as triggers for splitting the content into the plurality of data chunks. For instance, the system 102 may use structural markers (e.g., section headers, bullet points, numbered clauses) or formatting cues (e.g., bold text, indentation, font size) to define data-chunk boundaries.

The one or more heuristic procedures may further augment the process by applying custom rules based on domain knowledge, such as splitting content at common sentence lengths, logical connectors (e.g., “however,” “in another embodiment”), or at defined data volume thresholds to optimize memory and retrieval performance. The one or more heuristic procedures refer to experience-driven, domain-informed segmentation strategies that rely on practical rules rather than rigid predefined patterns or purely statistical AI models. The one or more heuristic procedures are configured to handle nuanced or less predictable content boundaries by leveraging contextual cues in patent specification generation. For instance, a heuristic procedure may split content when encountering certain logical connectors such as “however” or “in another embodiment,” which often signal a shift in context or scope. Similarly, it may segment text when sentences exceed a typical technical writing length, or when the volume of accumulated content in the data chunk approaches a threshold that could impact vector database retrieval efficiency. Unlike the one or more rule-based logics, the one or more heuristic procedures are flexible, adaptive, and tailored to the domain, allowing the system 102 to balance recall, precision, and processing performance in data chunking.

Each resulting data chunk is represented as a semantically meaningful data unit that preserves the technical integrity of its source content. For example, one data chunk may represent a detailed method step, another may describe the functionality of a figure element, and another may summarize a chemical composition. The plurality of data chunks are typically constructed to maintain self-contained interpretability, such that one or more AI models may accurately generate responses using a single data chunk or a small subset of related data chunks.

The data-chunking subsystem 212 is further configured to store the plurality of data chunks in the vector database within the one or more databases 104 using embedding-based indexing procedures. In this context, each data chunk is transformed into a high-dimensional embedding, a numeric vector that captures its semantic features, using a pretrained embedding model, which may be domain-agnostic or domain-specific. The generated embedding vectors are then indexed and stored in the vector database, which is configured to support fast, scalable similarity search. The embedding-based indexing procedures refer to the process of converting unstructured or structured data into high-dimensional numeric vectors (embeddings) that capture the semantic meaning, contextual relationships, or feature representation of the original content, and then storing these embeddings in a specialized vector database for efficient retrieval.

The embedding-based indexing procedures allow the system 102 to later retrieve the most relevant data chunks based on semantic similarity procedures, contextual relevance, or prompt alignment during patent specification generation. The vector database may support operations such as a nearest-neighbor search, a cosine similarity computation, or an attention-based data chunk selection to facilitate real-time interaction with the refined disclosure generating subsystem 214, the patent claims generating subsystem 220, and the specification-generating subsystem 222. The nearest-neighbor search operation enables the retrieval of plurality of data chunks that are most semantically similar to a query vector generated from the plurality of prompts or the one or more user defined prompts. This operation may be implemented using optimized indexing structures, such as, but not limited to, one of: hierarchical navigable small-world (HNSW) graphs, KD-trees, and product quantization techniques, to ensure that the plurality of data chunks retrieval occurs with minimal latency, even for large-scale datasets. The cosine similarity computation measures the angular similarity between the query vector and the stored plurality of data chunks, rather than relying solely on Euclidean distance. This allows the system 102 to prioritize the plurality of data chunks that are directionally aligned in the embedding space, which is particularly relevant when the query and the target plurality of data chunks have semantically equivalent content but differ in scale or magnitude. In the present disclosure, the cosine similarity scoring is used to rank retrieved data chunks, ensuring that the highest-ranked data chunks are contextually relevant to the target patent specification generation tasks, whether it is generating the refined invention disclosure, constructing the one or more claims, or generating the plurality of specification sections. For example, when a user provides a query prompt for generating a section of the patent specification, the system 102 converts the prompt into an embedding vector and compares it to stored embeddings using cosine similarity computation. This ensures that retrieved chunks are semantically aligned with the prompt, even if they differ in exact wording, thereby enabling accurate, real-time retrieval for generating refined invention disclosures, claims, or specification sections.

In an exemplary embodiment, the one or more user defined prompts comprise generating a system-type independent claim for the patentable subject matter of the disclosure, describing multiple interconnected hardware and/or software components, their interactions, and their collective operation to achieve a specific purpose; ensuring the claim clearly defines the essential elements while maintaining a balance between broad scope and enforceability; using <Assigned Figure(s)> from <Figure(s)> and <Refined Disclosure> as primary references; referring to <Disclosure Information> and <Prior Art Information> only as secondary sources if necessary; ensuring the claim adheres to statutory requirements, acceptable terminology, and formatting standards of the specified <Jurisdiction>; and presenting each claim element on a separate line, starting with a lowercase letter, with colons, semicolons, commas, and periods applied in accordance with established patent claim drafting conventions.

In an exemplary embodiment, the refined disclosure generating subsystem 214 is configured with a plurality of pre-defined sections comprising a plurality of queries. The plurality of pre-defined sections comprises, but not limited to, at least one of: general background, technical details, comparison with prior art, variations and modifications, usage and applications, additional information (which includes clarifying queries), and the like. Each query of the plurality of queries may correspond to logically and legally recognized elements typically present in the invention disclosure, such as, but not limited to, at least one of: name of the invention, summary of your invention, problem to be solved, target user or market for the invention, existing limitations, proposed solution overview, components and architecture, technical feature of the invention, ramification of the invention, summary of prior art references, novelty, inventive steps, functional advantages, variations, and the like. The structure of the plurality of queries within each section is configured to elicit complete, precise, and contextually aligned fine-tuned response that collectively result in a high-quality, legally viable refined invention disclosure.

Each query of the plurality of queries is characterized as a plurality of prompts for the one or more AI models to generate a fine-tuned response, by retrieving applicable data chunks within the plurality of data chunks from the vector database. The plurality of prompts are crafted to encourage detailed technical explanations, contextual justification, and unambiguous descriptions aligned with legal and patent specification generating standards. When a query is issued, either pre-defined in the system 102 or manually generated via user interaction, the refined disclosure generating subsystem 214 invokes the underlying AI model within the one or more AI models, which performs the semantic similarity procedures against the stored plurality of data chunks in the vector database. The underlying AI model selects the most contextually relevant data chunks based on vector proximity and uses them as grounding information to generate a coherent, accurate response specific to the query at hand.

The refined disclosure generating subsystem 214 is further configured to provide one or more clickable elements to generate the plurality of queries (additional) to add in the refined invention disclosure. The one or more clickable elements may be displayed as, but not limited to, one of: interactive buttons, drop-down menus, or expandable tiles within the user interface. The one or more clickable elements enable the one or more users to iteratively trigger additional queries aligned with a particular section or aspect of the invention. For example, a user may initiate a new query to elaborate on the operational steps of a method or to introduce an alternative configuration of a described system in the invention. This interactive mechanism empowers the one or more users to progressively refine the invention disclosure with targeted additions without needing to manually input freeform prompts.

The refined disclosure generating subsystem 214 is further configured to provide the fine-tuned response to each query of the plurality of queries using the one or more AI models by retrieving the applicable data chunks. The one or more AI models utilize the retrieved data chunks as contextual knowledge and apply natural language generation procedures to produce domain-specific, technically precise, and legally compliant narrative fine-tuned responses. The fine-tuned responses are tailored to the structure and intent of each query and are displayed in the corresponding pre-defined section for real-time review and editing.

In an exemplary embodiment, the one or more artificial intelligence models may be selected from a group comprises, but not limited to at least one of: transformer-based language models, recurrent neural network (RNN)-based models, long short-term memory (LSTM) models, bidirectional encoder representations from transformers (BERT) models, generative pre-trained transformer (GPT) models, encoder-decoder sequence-to-sequence models, semantic role labeling models, dependency parsing models, named entity recognition (NER) models, relation extraction models, question-answering models, abstractive summarization models, domain-specific fine-tuned large language models (LLMs) trained on annotated patent corpora, comparative analysis models, novelty detection models, contradiction analysis models, similarity scoring models, visual-textual alignment models, embedding similarity computation models, image recognition models, optical character recognition (OCR) parsers, natural language parsers, audio-to-text transcription modules, image parsers, chemical structure parsers, video parsers, metadata extractors, domain-specific structured data parsers, generative image models, edge detection models, vectorization models, and rule-based claims logic models.

The transformer-based language models utilize self-attention mechanisms to capture contextual relationships in the multi-modal data for precise generation of the patent specification. The RNN-based models process sequential patent data such as claim dependencies or procedural steps. The LSTM models capture long-range dependencies in technical disclosures for coherent output. The BERT models read textual information bidirectionally to enhance semantic comprehension. The GPT models generate the patent specification and the one or more claims. The encoder-decoder sequence-to-sequence models transform the extracted plurality of data chunks into a complete specification or the one or more claims. The semantic role labeling models identify functional roles of words or phrases to map disclosure features and relationships. The dependency parsing models determine grammatical and logical links between the one or more claims or the one or more labelled elements. The NER procedures detect and tag domain-specific entities such as component names, part numbers, and chemical identifiers. The relation extraction models identify structural, functional, or causal relationships between the one or more labelled elements in the one or more figures and text. The question-answering models retrieve precise responses to generating prompts from the stored plurality of data chunks. The abstractive summarization models create concise summaries of detailed invention disclosures. The domain-specific fine-tuned LLMs trained on annotated patent corpora adapt to patent terminology, formatting, and legal conventions. The comparative analysis models evaluate invention features against the plurality of prior art chunks to identify novel claimable subject matter. The novelty detection models flag unique technical features absent from the plurality of prior art data chunks. The contradiction analysis models detect conflicting statements in claims or specifications. The similarity scoring models rank the semantic closeness between prompts and the stored plurality of data chunks. The visual-textual alignment models synchronize figure elements with related text descriptions. The embedding similarity computation models measure closeness between vector embeddings of textual or visual patent data. The image recognition models detect and classify visual elements in the one or more figures. The OCR parsers extract text and labels from scanned or image-based figures. The natural language parsers analyze text for grammatical structure. The audio-to-text transcription modules convert spoken invention disclosures into textual form. The image parsers analyze visual content to extract figure details. The chemical structure parsers interpret molecular data from chemical drawings. The video parsers extract sequences from demonstration videos. The metadata extractors capture contextual metadata such as creation dates and technical categories. The domain-specific structured data parsers extract structured scientific or engineering data relevant to the invention's domain. The generative image models produce compliant patent illustrations from text or images. The edge detection models outline shapes and boundaries in the one or more figures. The vectorization models convert raster figures into scalable line-based formats. The rule-based claims logic models apply patent drafting rules to structure claims with correct preambles, transitions, and body elements.

The refined disclosure generating subsystem 214 is further configured to generate one or more clarifying queries based on detected indistinctness in at least one of: the multi-modal data, the plurality of data chunks, and the fine-tuned response associated with each query of the plurality of queries. The indistinctness detection may involve the application of linguistic ambiguity checks, logical inconsistency checks, or content completeness analysis. For instance, if the one or more AI models detect missing antecedent references, unexplained component functions, or contradictory statements in a generated fine-tuned response, the refined disclosure generating subsystem 214 may automatically formulate a clarifying query to seek further information or validation. This ensures that the refined invention disclosure evolves toward higher clarity, coherence, and alignment with statutory requirements.

The refined disclosure generating subsystem 214 is further configured to generate the fine-tuned response to each clarifying query of the one or more clarifying queries by processing the applicable data chunks within the plurality of data chunks using at least one of: Teoriya Resheniya Izobretatelskikh Zadatch (TRIZ) principles, the semantic similarity procedures, the contextual co-occurrence procedures, and the dependency mapping procedures. The TRIZ principles are applied to reason through inventive problems, contradictions, and improvement suggestions based on recognized engineering problem-solving patterns. The TRIZ involves breaking down complex problems into simpler, manageable components using the 40 TRIZ principles. The refined disclosure generating subsystem 214 applies relevant TRIZ principles to resolve these contradictions. For instance, it might use the “separation principle” to suggest ways to achieve both strength and lightness by proposing new materials or structural designs. Based on the TRIZ principles, the refined disclosure generating subsystem 214 generates multiple potential solutions. The refined disclosure generating subsystem 214 uses capability of the one or more AI models to predict the feasibility and effectiveness of these solutions.

The semantic similarity procedures refer to computational techniques that measure how closely two pieces of text are related in meaning, even if they use different words or phrasing. The semantic similarity procedures enable the one or more AI models to locate related content in the vector database even when expressed in different wording. Technically, the semantic similarity procedures work by converting both the query text (e.g., a section prompt from the refined disclosure generating subsystem) and all stored plurality of data chunks into dense numerical representations, also called embeddings. These embeddings capture contextual meaning, domain-specific terminology, and relationships between words. Once represented as embeddings, similarity scoring functions, such as cosine similarity, the Euclidean distance, or the Manhattan distance, are applied to determine how close the meanings are. For instance, the refined disclosure generating subsystem 214 issues a query for “methods of controlling thermal dissipation in the device.” The vector database may contain a chunk that reads “techniques for managing heat output from the apparatus.” Even though no key terms match exactly (“thermal dissipation” vs. “heat output”), the semantic similarity procedures will recognize that the concepts are equivalent because their embeddings are close in the vector space. The semantic similarity procedures then retrieves this chunk as relevant material to be used in generating the detailed description.

The contextual co-occurrence procedures refer to computational techniques that detect and leverage patterns in which certain terms, technical elements, or concepts appear together within the multi-modal data, the plurality of data chunks, or the refined invention disclosure. The contextual co-occurrence procedures allow the refined disclosure generating subsystem 214 to correlate elements that frequently appear together, thereby enhancing contextual completeness. The contextual co-occurrence procedures operate by analyzing frequency distributions and proximity relationships between words, phrases, or labeled elements, identifying associations that are statistically significant or domain-specific. For example, in a mechanical engineering context, the terms “rotor” and “stator” often co-occur; in a chemical disclosure, “catalyst” may frequently appear with “reaction temperature” and “yield percentage.” Within the refined disclosure generating subsystem 214, the contextual co-occurrence procedures are applied during the retrieval and assembly of content for each query or clarifying query. When the refined disclosure generating subsystem 214 encounters a technical element, it checks the vector database for other elements that have historically appeared in close proximity to the source data. This ensures that related supporting details, such as operational conditions, structural relationships, or performance parameters, are retrieved alongside the main element, thereby increasing the contextual completeness of the refined invention disclosure. For instance, If a chunk in the vector database contains “a photovoltaic cell” and another chunk contains “maximum conversion efficiency,” the contextual co-occurrence procedures may determine that “conversion efficiency” is a relevant attribute of “photovoltaic cell” based on repeated co-occurrence in training data and prior disclosures. As a result, when generating the technical description of the photovoltaic cell, the refined disclosure generating subsystem 214 automatically pulls in the associated efficiency details, avoiding omissions and ensuring completeness without requiring explicit user prompts.

The dependency mapping procedures refer to computational methods configured to identify and model logical, hierarchical, or referential dependencies between different concepts, components, or procedural steps described in the multi-modal data, the plurality of data chunks, and the refined invention disclosure. The dependency mapping procedures rely on dependency parsing techniques from the natural language processing (NLP), which analyze the grammatical structure of sentences to determine the syntactic and semantic relationships between words or phrases. They also incorporate cross-reference tracking, structural mapping, and relational graph construction to maintain consistency in how related elements are described and connected throughout the generated patent specification. The dependency mapping procedures trace interlinked concepts and references across the multi-modal data, allowing for logically and structurally consistent generation. For instance, If the multi-modal data describes “a chemical reactor” that “comprises a heating unit, a temperature control module, and a safety shut-off valve,” the dependency mapping procedures identify that the “heating unit” and “temperature control module” are dependent on the reactor's definition, and that the “safety shut-off valve” is functionally tied to the heating unit. When generating the refined invention disclosure or the one or more claims, the dependency mapping procedures ensure that the reactor is introduced first, followed by its subcomponents in the correct logical order, and that functional interconnections (e.g., “the safety shut-off valve is configured to interrupt power to the heating unit upon overheating”) are preserved consistently across the claims, detailed description, and figure descriptions.

The refined disclosure generating subsystem 214 is further configured to compile the plurality of queries and the one or more clarifying queries with the associated fine-tuned responses into a structured disclosure output as the refined invention disclosure. This compilation step aggregates all individually generated and iteratively refined fine-tuned responses into a unified, section-wise organized document that is ready for downstream use in claim generation, specification drafting, and illustration preparation. The structured refined invention disclosure output preserves the logical flow of information, ensures terminology consistency, and aligns with the expected format for a jurisdictionally compliant patent specification foundation.

In an exemplary embodiment, the illustrations preparation subsystem 216 is configured to at least one of: extract the one or more figures from the multi-modal data, obtain prepared illustration data from at least one of: the one or more cloud storage services and the one or more end devices, generate the one or more figures based on the refined invention disclosure, and provide a figure-editor tool for generating the one or more figures. The illustrations preparation subsystem 216 serves as a dedicated component for managing the acquisition, transformation, generation, and refinement of one or more figures, which are a critical part of patent specification and must comply with technical illustration standards defined by jurisdictional guidelines.

The illustrations preparation subsystem 216 is configured to enable the extraction of one or more figures from the multi-modal data, which may include embedded illustrations in scanned invention disclosures, screenshots in presentation decks, sketches in image files, or computer-aided design (CAD)-rendered views. To support this extraction, the illustrations preparation subsystem 216 is configured with the one or more OCR parsers that are capable of detecting and isolating graphical regions from unstructured or semi-structured content sources. The one or more OCR parsers may utilize bounding box detection, layout analysis, and image segmentation to accurately distinguish the one or more figures from surrounding text, annotations, or background artifacts. Extracted the one or more figures are optionally tagged with positional metadata and linked back to their source documents for traceability and verification.

In scenarios where the one or more figures are not embedded in the uploaded multi-modal data but are available separately, the illustrations preparation subsystem 216 is further configured to obtain prepared illustration data from the one or more cloud storage services and the one or more end devices 106. This functionality allows the one or more users to directly import pre-existing images, CAD exports, or scanned drawings into the system 102 through secure APIs, upload widgets, or file selection interfaces. The illustrations preparation subsystem 216 supports multiple standard formats including but not limited to: JPEG, PNG, SVG, TIFF, PDF, Drawing (DWG), Standard for the Exchange of Product Model Data (STEP), and the like.

Where the one or more figures are not pre-supplied or require supplementation, the illustrations preparation subsystem 216 is further configured to generate the one or more figures based on the refined invention disclosure. This generation capability is enabled by leveraging semantic extraction from the refined invention disclosure, such as at least one of: structural component descriptions, spatial relationships, method steps, functional flow, and the like. The illustrations preparation subsystem 216 maps these extracted entities into geometric primitives, layout structures, and illustrative elements which may be rendered into line drawings using internal image generation pipelines.

The illustrations preparation subsystem 216 further comprises a generative image model configured to convert the one or more figures in one of: hand drawn figures, photographic figures, and CAD-based three-dimensional figures into line drawings conforming to the jurisdictional guidelines. The generative image model may employ a combination of convolutional neural networks, edge detection filters, and vectorization models to abstract visual detail and generate standardized black-and-white line art with appropriate thickness, labeling areas, and whitespace margins. For instance, a hand-drawn schematic uploaded as a raster image may be processed into a clean, vectorized version suitable for patent application submission. Similarly, a 3D CAD model may be auto-projected into orthographic views (top, front, side) with exploded component breakdowns and reference numerals inserted based on label mapping. All the generated one or more figures are formatted to meet regulatory constraints on size, resolution, font usage, line weights, and label placement, as defined by the selected jurisdiction template.

The generative image model employed within the system 102 may leverage a combination of advanced image processing and machine learning techniques, including the convolutional neural networks (CNNs), the edge detection filters, and the vectorization models, to automatically transform the one or more figures, such as the hand-drawn figures, photographs, or CAD-rendered figures, into clean, compliant line drawings suitable for patent illustrations. The CNNs are utilized to analyze and interpret complex pixel patterns within the one or more figures. These CNNs are composed of multiple layers that sequentially extract features from low-level elements such as edges, contours, and textures, to high-level structures like component boundaries and spatial relationships. The CNNs are particularly effective at handling noisy or unstructured inputs such as hand drawn figures or photos taken in uncontrolled lighting environments. By learning spatial hierarchies and contextual features, the CNNs are able to distinguish between foreground objects (e.g., technical parts) and background clutter and classify image regions relevant for the one or more figures reconstruction.

In conjunction with the CNNs, the edge detection filters are applied to enhance the visibility and definition of structural boundaries within the one or more figures. The edge detection filters such as, but not limited to, one of: sobel, canny, and laplacian operators, are used to detect significant changes in pixel intensity that typically correspond to object edges. The resulting edge maps form a foundation for identifying component outlines, sectional cuts, or interconnections that are crucial in technical illustrations. This edge enhancement step improves the clarity and segmentation accuracy during the vectorization process, ensuring that meaningful lines are captured while minimizing visual noise.

Following edge detection, the generative image model is configuring to employ the vectorization models to convert raster-based pixel data into scalable vector graphics. Vectorization is the process of transforming bitmap features into mathematically defined paths, such as lines, curves, and polygons, which may be precisely scaled or edited without loss of resolution. Other models like Potrace or custom Bezier curve fitting procedures may be used to trace the detected edges and extract continuous geometric representations. This step ensures that the output of the one or more figures comply with the jurisdictional guidelines requirements for line quality, annotation clarity, and reproducibility in digital and print formats. The vector output also allows for dynamic editing in figure-editor tools, where the one or more users are able to add labels, arrows, or reference numbers directly to the vector layers.

Additionally, the illustrations preparation subsystem 216 provides a figure-editor tool which allows the one or more users to make manual or guided modifications to the generated one or more figures. This includes adding, removing, or re-positioning labels, adjusting drawing components, inserting reference indicators, or overlaying annotations. The figure-editor tool may support drag-and-drop interfaces, layer-based editing, and real-time preview functionality, giving the one or more users granular control over figure quality, accuracy, and compliance.

In an exemplary embodiment, the figure description generating subsystem 218 is configured to generate description associated with the one or more figures by mapping at least one of: the plurality of data chunks and the refined invention disclosure, with at least one of: one or more label numbers and one or more label names, extracted from each figure of the one or more figures. The figure description generating subsystem 218 is configured to connect a visual content with corresponding textual narrative in the patent specification, thereby ensuring that each figure of the one or more figures is appropriately referenced, described, and integrated within the overall disclosure.

The figure description generating subsystem 218 is configured to perform one of: optical extraction and semantic extraction of at least one of: the one or more label numbers and the one or more label names from each figure of the one or more figures using at least one of: one or more image recognition models and natural language processing models. The optical extraction process utilizes computer vision techniques such as the one or more OCRs, contour detection, and bounding box localization to identify the one or more label numbers, embedded in the one or more figures and the associated one or more label names from the plurality of data chunks and the refined invention disclosure. The one or more label names typically denote structural components, subassemblies, or system elements. In parallel, semantic extraction may be used to identify implied or indirect labels from surrounding visual context, such as arrows, flow paths, or grouped symbols, by employing trained image recognition models capable of classifying components and associating them with likely roles. Additionally, natural language processing models may analyze any figure captions or embedded text near the image to retrieve complementary labeling data.

The figure description generating subsystem 218 is configured to contextually map the one or more label names with corresponding one or more labelled elements (such as, but not limited to, one of: structural components, functional modules, data interfaces, electronic circuits, software blocks, user interface elements, mechanical linkages, chemical containers, reaction chambers, optical paths, and biological units) in the refined invention disclosure and the plurality of data chunks by using at least one of: relation extraction models, visual-textual alignment models, embedding similarity computation procedures, and the named entity recognition (NER) procedures. Once one or more label names are extracted from the one or more figures, the figure description generating subsystem 218 performs semantic grounding to ensure they correspond to accurate and meaningful descriptions in the textual narrative.

In an exemplary embodiment, the relation extraction models are artificial intelligence models trained to identify and categorize semantic relationships between entities within textual data by analyzing contextual cues, linguistic patterns, and co-occurrence structures. The relation extraction models are employed to detect functional, structural, or causal relationships between the identified one or more labelled elements within the refined invention disclosure and associate them with respective visual elements. In the context of the present disclosure, such the relation extraction models determine how each labelled element within the one or more labelled elements relates to others, whether a component physically connects to another (structural), operates in coordination with another (functional), or directly influences the operation or state of another (causal). In one exemplary embodiment, if the refined invention disclosure describes a “controller” (labelled element) that regulates the “motor” (labelled element) speed based on input from a “sensor” (labelled element), the relation extraction models automatically detects and categorizes these as: a causal relationship between the sensor and the controller, and a functional relationship between the controller and the motor. These detected relationships are then mapped to the corresponding labelled elements in the one or more figures, enabling accurate figure descriptions that capture both the spatial arrangement and the operational interdependencies.

In an exemplary embodiment, the visual-textual alignment models are artificial intelligence models trained to correlate and synchronize visual elements in figures with corresponding descriptive elements in textual content, using a combination of computer vision techniques, natural language processing, and domain-specific knowledge. The visual-textual alignment models analyze spatial structures, positional layouts, and graphical indicators in the one or more figures, and match them with corresponding verbal descriptions in the refined invention disclosure or the plurality of data chunks. The visual-textual alignment models synchronize spatial components in the one or more figures with their verbal counterparts based on domain-specific knowledge and visual layouts. Additionally, the embedding similarity computation procedures are used to match one or more label names with semantically equivalent terms within the text, even when terminology varies. For instance, a label “Controller 004” in the figure might be mapped to a sentence in the disclosure describing “a control module” by computing the proximity in embedding space.

In an exemplary embodiment, the NER procedures are natural language processing models configured to automatically identify, classify, and tag named entities within textual data. The NER procedures further assist by detecting and categorizing technical terms, component names, and entities for consistent alignment. The NER procedures are configured to identify domain-specific entities such as part numbers, functional module names, chemical compound identifiers, molecular structure references, biological sequences, and jurisdiction-specific legal terms. Once detected, these entities are tagged and cross-referenced with corresponding occurrences in the plurality of data chunks, the refined invention disclosure, the description associated with the one or more figures, and the generated one or more claims. This ensures that terminology is used consistently across all specification sections, preventing ambiguity and reducing the risk of rejection during patent examination for lack of clarity or inconsistent naming. The NER procedures may employ transformer-based entity recognition models fine-tuned on annotated patent corpora, enabling high-accuracy recognition of multi-word technical terms and nested entities that are common in patent drafting. Furthermore, these procedures facilitate the creation of an internal entity map that the specification-generating subsystem 222 and the patent claims generating subsystem 220 may reference during patent specification generation, ensuring uniform term usage throughout the one or more claims, detailed description, and the description associated with the one or more figures. In one exemplary embodiment, when the refined invention disclosure contains the term “data processing unit” and the corresponding figure label reads “processor module 210,” the NER procedures detect both as referring to the same functional entity. The procedures then create an internal entity map linking these variations, enabling the specification-generating subsystem 222 and the patent claims generating subsystem 220 to reference the same standardized term, “data processing unit,” throughout the one or more claims, detailed description, and the description associated with the one or more figures. This automated alignment ensures both terminological consistency and compliance with jurisdiction-specific clarity requirements.

The figure description generating subsystem 218 is further configured to generate the description associated with the one or more figures comprising at least one of: structural identification, functional role, spatial relationship, and interconnection of the one or more labelled elements. The structural identification refers to the process of recognizing and naming the physical or visual structure of a labelled element in each figure. In the system 102, this is achieved by analyzing the geometry, contours, and spatial boundaries of the labelled element from each figure and associating it with its corresponding entity name. For example, a rectangular block with connectors in a system diagram may be structurally identified as a “processing unit” or “power module”. The functional role defines what the labelled element does within the disclosure. The functional role links the labelled element to its operational purpose as described in the refined invention disclosure or the one or more claims. For instance, if the labelled element is “controller module 302,” its functional role might be “manages input signals and regulates actuator movement”. The spatial relationship describes the positional arrangement of the labelled element with respect to other one or more labelled elements in the one or more figures. The spatial relationship may indicate adjacency, containment, directionality, or proximity. For example, “sensor unit 210 is positioned adjacent to the input module 208” or “display screen is mounted above the processing unit.” The interconnection of the one or more labelled elements refers to the physical or logical linkage between the one or more labelled elements, defining how data, signals, power, or materials flow between them. In the one or more figures, the interconnection is often represented by lines, arrows, or connection symbols, and the system 102 interprets these to generate accurate descriptions. For instance, “the communication interface module 214 is electrically connected to the processing unit 216 via a high-speed serial bus.”

The generated descriptions provide a detailed narrative description for each figure, clearly identifying what each labeled component is, what its role, where it is located with respect to other components, and how it interacts or connects with those components. For example, a structural identification may state that “element 1 represents a housing body,” a functional role may indicate “element 2 operates as a thermal regulator,” a spatial relationship may describe “element 3 is positioned above element 4,” and an interconnection may explain “element 5 is electrically coupled to element 6.” These figure descriptions are structured in natural language sentences or paragraphs, formatted according to jurisdictional guidelines for patent figure referencing, and inserted into the corresponding section of the specification or description of drawings.

In an exemplary embodiment, the patent claims generating subsystem 220 is configured to generate one or more claims in a user selected claim templet within one or more predefined claim templates, based on analyzing at least one of: one or more prior art chunks in the plurality of chunks, the figure descriptions, and the refined invention disclosure, using at least one of: the one or more AI models and the one or more user defined prompts. The patent claims generating subsystem 220 automates the generation of the one or more claims by synthesizing multiple internal representations of the invention, enabling structured generation of the one or more claims that are aligned with legal, technical, and jurisdictional requirements.

The patent claims generating subsystem 220 is configured to classify the user-selected claim template as one of, but not limited to, a method claim, a system claim, a product claim, a process claim, and the like. This classification step enables downstream components to structure a claim body in accordance with expected legal syntax, claim categories, and enforceability standards. For example, a method claim may emphasize procedural steps and transitions, while a system claim would detail structural components and their interrelations.

To determine what aspects of the invention are claimable, the patent claims generating subsystem 220 is configured to extract claimable subject matter from at least one of: the refined invention disclosure, the description associated with the one or more figures, and the one or more prior art data chunks, using the one or more AI models. The one or more AI models comprising one or more natural language processing models for semantic parsing. The one or more natural language processing models are trained to identify semantically meaningful structures from the multi-modal data, including verbs indicating actions, nouns describing elements, and modifiers detailing constraints or conditions. The semantic parsing enables the decomposition of complex narrative sentences into discrete claimable elements such as features, functions, inputs, outputs, and configurations. The one or more natural language processing models are selected from a group comprises at least one of: transformer-based language models, recurrent neural network (RNN)-based models, long short-term memory (LSTM) models, bidirectional encoder representations from transformers (BERT) models, generative pre-trained transformer (GPT) models, encoder-decoder sequence-to-sequence models, semantic role labeling models, dependency parsing models, the NER models, relation extraction models, question-answering models, abstractive summarization models, and domain-specific fine-tuned large language models (LLMs) trained on annotated patent corpora. The one or more natural language processing models. In an exemplary enablement scenario, the patent claims generating subsystem 220 employs a domain-specific fine-tuned transformer-based language model, such as a BERT variant trained on annotated patent corpora, to process the refined invention disclosure and detect claimable subject matter. For instance, consider a portion of the refined invention disclosure stating: “The control module receives sensor input data, processes the data using a machine learning algorithm, and adjusts the actuator output to maintain optimal system performance under varying environmental conditions.” The one or more natural language processing models for semantic parsing analyze this sentence to identify verbs indicating actions, such as receives, processes, and adjusts, nouns describing elements, such as control module, sensor input data, machine learning algorithm, actuator output, system performance, and environmental conditions, and modifiers detailing constraints or conditions, such as using a machine learning algorithm, to maintain optimal system performance, and under varying environmental conditions. The semantic parsing then decomposes the narrative into discrete claimable elements, for example: a control module configured to receive sensor input data; the control module further configured to process the data using a machine learning algorithm; the control module further configured to adjust actuator output; and the adjustment being performed to maintain optimal system performance under varying environmental conditions. These claimable elements are then structured into a legally compliant claim format, with a preamble, transitional phrase, and body clauses, in accordance with jurisdiction-specific drafting requirements, ensuring logical connection between features and preservation of the inventive scope.

The one or more AI models comprising one or more comparative analysis models to distinguish novel features from the one or more prior art data chunks. The one or more comparative analysis models involves systematically comparing two or more entities, ideas, or situations to identify similarities, differences, and patterns. The one or more comparative analysis models compare the extracted elements of the invention against known prior art representations embedded within the prior art data chunks. The one or more comparative analysis models may rely on one of: similarity scoring functions, novelty detection models, and contradiction analysis to highlight claim-worthy innovations, such as those demonstrating unexpected advantages or unique configurations. Each sentence, phrase, or identified technical feature in the multi-modal data is first converted into a vector representation using embedding models (e.g., Bidirectional Encoder Representations from Transformers (BERT), Sentence-BERT, or custom domain-specific encoders). This transformation ensures that syntactic and semantic meanings are preserved in a high-dimensional numerical space, allowing for efficient similarity comparison between different elements. For example, the feature “a fluidic control valve configured to dynamically regulate pressure” is encoded into a vector that captures its meaning, function, and related context, and then be compared to similar statements in the prior art data chunks associated with the one or more prior arts. To compare the plurality of data chunks with the plurality of prior art data chunks, the comparative analysis model employs similarity scoring functions such as: the cosine similarity, the Euclidean distance, the Manhattan distance, Jaccard similarity, and the like. The similarity scoring functions compute how closely each data chunk resembles its closest match in the prior art data chunks. If the similarity score crosses a defined threshold (indicating high overlap), the patent claims generating subsystem 220 flags the feature as known or potentially anticipated. If a low similarity score is observed across all prior art, the feature is marked as a potentially novel aspect. To go beyond surface-level similarity, the patent claims generating subsystem 220 employs one or more novelty detection models trained on historical patent examination data, where novel vs. non-novel decisions are annotated. The one or more novelty detection models use supervised learning, anomaly detection, or contrastive learning methods to identify patterns that suggest a feature is unique by analyzing combinations of features (e.g., “feature A+feature B in a specific configuration”), assess use in new contexts, or evaluate functionality not seen in similar mechanisms.

In an exemplary embodiment, the cosine similarity metric is employed by the comparative analysis model to measure a degree of alignment between vector embeddings of the plurality of data chunks and the plurality of prior art data chunks. Since the plurality of data chunks are stored in the vector database using embedding-based indexing procedures, the cosine similarity metric calculates the cosine of the angle between two high-dimensional vectors representing semantic meaning. A cosine similarity score closer to 1.0 indicates that the content of the chunk is semantically similar to the prior art data chunk, even if the exact wording differs. This makes cosine similarity particularly effective in identifying prior art that uses different terminology but conveys substantially the same technical concept.

In an exemplary embodiment, the Euclidean distance metric is used to measure the absolute geometric distance between two data chunks of the plurality of data chunks in the embedding space. A lower Euclidean distance signifies that the two data chunks share a high degree of similarity in both terminology and contextual representation. In the present system 102, Euclidean distance helps identify near-identical disclosures, diagrams, or procedural descriptions that might not be captured solely by semantic similarity measures.

The Manhattan distance metric (also known as L1 distance) computes the sum of the absolute differences between each corresponding vector dimension. Unlike Euclidean distance, which is sensitive to outlier dimensions, the Manhattan distance metric provides a more uniform penalty across all vector components. In the present system 102, the Manhattan distance metric aids in detecting similarities where the chunk structure is altered but the core set of technical features remains constant, making it valuable for catching reworded or reformatted prior art disclosures.

The Jaccard similarity metric is applied primarily to tokenized representations of textual data chunks within the plurality of data chunks, measuring the ratio of shared tokens (words, identifiers, or technical terms) to the total number of unique tokens in the two data chunks. A high Jaccard similarity score indicates significant lexical overlap, which may point toward potential anticipation. Within the present system 102 the Jaccard similarity metric is also applied to symbolic or structural data, such as lists of claim elements, labelled figure components, or chemical identifiers, to determine whether a substantial portion of elements matches the plurality of prior art chunks.

The one or more AI models comprising dependency parsing to determine logical relationships between technical features in the plurality of data chunks: The patent claims generating subsystem 220 applies syntactic dependency parsing models to map out how technical features relate to one another. For example, if feature A “controls” feature B, or if feature C “is embedded within” feature D, the dependency parser identifies these as hierarchical or functional dependencies, which are essential when organizing independent and dependent claims.

The one or more AI models comprising a rule-based claims logic prompts for constructing preamble, transitional phrases, and body elements: The patent claims generating subsystem 220 incorporates rule-driven templates that define how each part of a claim should be structured based on the type of claim. The preamble generally identifies the subject of the invention, the transitional phrase (e.g., “comprising,” “consisting of”) sets claim boundaries, and the body lists the essential limitations. These rules ensure consistency and legal soundness of the generated claims.

The patent claims generating subsystem 220 is configured to generate the one or more claims comprising at least: an independent claim and one or more dependent claims. The independent claim captures the broadest allowable scope of the invention, integrating all necessary limitations to distinguish it from prior art, while the dependent claims add refinements, optional components, or alternative embodiments that fall within the scope of the independent claim. To ensure compliance with jurisdictional guidelines, the patent claims generating subsystem 220 is further configured to validate the one or more claims against predefined jurisdiction-specific claim drafting rules, including at least one of: number of claims, unity of an invention, and dependency constraints. A specification validation module 222a ensure that the generated one or more claims do not violate format, scope, or dependency rules, thereby reducing the likelihood of office action rejections and improving the likelihood of successful prosecution.

In an exemplary embodiment, the specification-generating subsystem 222 is configured with a plurality of specification sections, each corresponding to a distinct and jurisdictionally recognized component of a patent specification. The plurality of specification sections comprising at least one of, but not limited to, a title section, a cross-references section, a technical field section, a background section, objectives of the invention section, a summary of the invention section, a brief description of the drawings, a detailed description section, an abstract, and one or more optional jurisdiction-defined sections. The plurality of specification sections are configured to reflect both the structural expectations of various jurisdictional guidelines and the logical flow required for disclosing technical subject matter in a manner that satisfies statutory requirements under applicable jurisdictional guidelines.

Each specification section within the plurality of specification sections is characterized as the one or more prompts for the one or more AI models. The one or more prompts are programmatically or interactively invoked to guide the one or more AI models in generating specification responses that are accurate, complete, and aligned with the invention's technical disclosures. In generating each specification section, the specification-generating subsystem 222 is configured to retrieve relevant information from at least one of: the applicable data chunks from the plurality of data chunks, the refined invention disclosure, the description associated with the one or more figures, and the generated one or more claims. This retrieval ensures that each specification section is grounded in the previously analyzed and indexed content specific data.

To perform the task effectively, the specification-generating subsystem 222 utilizes at least one of, but not limited to, the NER procedures, relation extraction procedures, dependency parsing procedures, action mapping procedures, and the like. The NER procedures are configured to identify domain-specific entities such as component names, operations, measurements, and materials. The relation extraction procedures is a natural language processing (NLP) task focused on identifying and classifying relationships between entities in text. The relation extraction procedures are applied to infer semantic relationships among these entities, such as “component A is connected to component B” or “step C causes transformation in module D.” The dependency parsing procedures are computational techniques in the natural language processing (NLP) that analyze the grammatical structure of sentences to determine how words are related to each other, specifically identifying which words are “heads” (governing terms) and which are “dependents” (terms that modify or relate to the heads). The dependency parsing procedures analyze sentence structures to map hierarchical or functional dependencies between features. For instance, consider the sentence: “The sensor assembly detects temperature variations and transmits a signal to the control unit, which adjusts the cooling fan speed accordingly.” The dependency parsing procedures generate a dependency tree that identifies “sensor assembly” as the subject, “detects” and “transmits” as main actions, “temperature variations” and “signal” as corresponding objects, “control unit” as the indirect object, and “adjusts the cooling fan speed” as a subordinate action linked to the control unit. This parsing process allows the system 102 to recognize that the sensor assembly performs detection and transmission functions, the control unit performs adjustment functions, and the cooling fan is the component being controlled. By maintaining these structural and functional relationships, the dependency parsing procedures ensure that the generated claims, detailed description, and figure descriptions consistently reflect the operational hierarchy and interconnections of the invention's components.

The action mapping procedures analyze both the linguistic context and the structural arrangement of data chunks to map “who” or “what” performs a given action, “what” is acted upon, and “how” or “under what conditions” the action occurs. The action mapping procedures may employ a combination of natural language processing techniques, such as semantic role labeling, predicate-argument structure analysis, and domain-specific verb classification, to ensure accurate linkage between actions and their respective elements. The action mapping procedures are used to determine procedural flows, especially in sections such as the detailed description section, where the sequential operation of components must be presented clearly and unambiguously. For example, in the sentence: “The specification-generating subsystem 222 parses chemical structure files to generate normalized molecular representations,” the action mapping procedures identify “parses” as the primary action, associate it with the “the specification-generating subsystem 222” as the actor, and link “chemical structure files” as the target object. A secondary mapping links “generate” as another action performed by the specification-generating subsystem 222, with “normalized molecular representations” as the output. By preserving these mappings, the artificial intelligence-based system ensures that the generated one or more claims and the plurality of specification sections accurately describe not only the components but also the specific operations they perform, maintaining functional clarity and legal enforceability.

Further, the specification-generating subsystem 222 is configured to maintain internal consistency across the plurality of specification sections. This is achieved by validating that each element recited in the generated one or more claims is supported in at least one of the generated specification responses. For instance, any claim language referring to specific components, actions, or outcomes must have a corresponding elaboration or enablement in the detailed description section. Similarly, each figure referred to in the brief description of the drawings description section and detailed description section is checked against the actual figure descriptions and corresponding one or more label names to ensure correct referencing and technical coherence.

In an exemplary embodiment, the patent claims generating subsystem 220 and the specification-generating subsystem 222 are configured with the plurality of domain-specific generative AI agents. The model training subsystem 228 is configured to train and finetune the plurality of domain-specific generative AI agents on the plurality of examination reports, which are documents issued by various patent offices in the course of patent prosecution, detailing objections, rejections, amendments, and examiner comments corresponding to prior art, claim clarity, scope, enablement, and legal compliance.

The model training subsystem 228 is configured to train the plurality of domain-specific generative AI agents using supervised learning procedures, wherein the input training data comprises annotated examination reports paired with successful claim amendments and specification revisions. This supervised learning enables the plurality of domain-specific generative AI agents to develop a deep understanding of both explicit and implicit patterns that typically lead to successful patent grants or examiner satisfaction. For example, the plurality of domain-specific generative AI agents learns how certain claim terms are routinely objected to due to indefiniteness, lack of antecedent basis, or overbreadth, and how such issues are resolved through rewording, structural reformulation, or limiting amendments.

The plurality of domain-specific generative AI agents are therefore configured to adapt claim phrasing to avoid terminology known to trigger clarity or subject-matter objections in the relevant domain such as, but not limited to, at least one of: mechanical engineering, electrical systems, biotechnology, artificial intelligence, pharmaceuticals, and the like. The plurality of domain-specific generative AI agents are also configured to refine claim structure, including proper segmentation of preamble, transitional phrases (such as “comprising”, “consisting of”, “configured to”), and claim body language, in line with domain and jurisdictional drafting conventions. Further, the plurality of domain-specific generative AI agents manage claim dependency relationships by ensuring that dependent claims logically and legally follow from their independent claims, and that claim comply with constraints such as unity of invention and allowable dependency trees per jurisdiction.

Additionally, the plurality of domain-specific generative AI agents are employed to generate the specification responses across the plurality of specification sections, ensuring that the language and structure of each specification section align with jurisdictional practices and examiner expectations. For example, in technical fields such as biotech or semiconductors, where examiners often demand detailed enablement and sequence alignment, the plurality of domain-specific generative AI agents are trained to expand the plurality of specification sections like the detailed description and technical field accordingly. By learning from frequently encountered objections in the plurality of examination reports, the one or more domain-specific generative AI agents proactively structure the drafted content to reduce the risk of rejections under statutory sections. The specification-generating subsystem 222 then uses the selected solutions to generate detailed patent specifications. The specification-generating subsystem 222 ensures that the specifications include comprehensive descriptions of the invention's novel features, technical advancements, and operational mechanisms.

In an exemplary embodiment, the specification-generating subsystem 222 further comprises the specification validation module 222a. The specification validation module 222a is configured to systematically evaluate each specification section of the plurality of specification sections generated by the specification-generating subsystem 222, to ensure legal and technical correctness, as well as internal and external consistency. The validation is performed by comparing the generated specification responses against a defined set of rules and constraints, which include at least one of: terminology associated with the one or more claims, formatting rules, language guidelines, and completeness requirements specific to the selected jurisdiction.

The terminology associated with the one or more claims is cross-verified against each of the generated specification sections to ensure that all claimed elements, such as system components, process steps, materials, or functional units, are sufficiently supported by disclosure in the detailed description, are consistently labeled in the description associated with the one or more figures, and are properly referenced within the summary and background sections. For example, if a claim recites “a contextual metadata extraction module,” the specification validation module 222a ensures that the same phrase or its clearly defined synonym is described in the detailed description section and appears with proper alignment in the one or more figures and the corresponding detailed descriptions sections.

The specification validation module 222a is further configured to verify formatting rules such as section ordering, numbering conventions, paragraph structure, alignment of the one or more figures callouts, and consistency with jurisdictional section headings. This ensures that the entire specification conforms to submission standards issued by patent offices such as the United States Patent and Trademark Office (USPTO), the European Patent Office (EPO), the World Intellectual Property Organization (WIPO), Indian Patent Office (IPO), and among others.

To enforce language guidelines, the specification validation module 222a performs checks for grammar, passive vs. active voice use, overly broad or profanity terms, and compliance with formal legal drafting styles expected in technical disclosures. For instance, the specification validation module 222a ensures that speculative phrases or marketing-like language is avoided, and that the technical explanation remains objective and descriptive, facilitating clear understanding and examination by the one or more users. The completeness requirements are evaluated by ensuring that every section includes the mandatory content expected for sufficiency of disclosure under relevant patent law, such as enablement, best mode (if applicable), and industrial applicability, by assessing whether all necessary components, interrelations, and operational steps are adequately described.

For performing such analysis, the specification validation module 222a is configured to use at least one of: the NER procedures, a jurisdiction rules validator configured with regex patterns, and one or more large language models (LLMs) trained on legal drafting datasets. The NER procedures extract key technical and legal entities, such as component names, functional verbs, materials, and system relationships, which are then used to build a contextual map for validation. The jurisdiction rules validator uses regex patterns (regular expressions) to identify and flag deviations from predefined jurisdictional formatting standards, such as incorrect section titles, improper line breaks, or missing transitional phrases.

The one or more LLMs trained on legal drafting datasets act as intelligent analyzers capable of contextually interpreting specification content and comparing the generated patent specification against trained examples of compliant specifications. The one or more LLMs are fine-tuned to recognize subtle patterns in claim support, figure alignment, and linguistic structure, enabling detection of both overt and latent compliance risks. For instance, the one or more LLMs are able to flag instances where the one or more claims are not adequately enabled or where the one or more dependent claims introduce unsupported limitations, prompting the specification validation module 222a to suggest automated corrections or highlight issues for user review. By integrating these layers of intelligent analysis, the specification validation module 222a ensures that the patent specification not only meets technical and legal drafting expectations but also proactively mitigates risks of post-filing objections or office actions, thereby increasing the quality and efficiency of patent prosecution.

In an exemplary embodiment, the at least one of: the refined disclosure generating subsystem 214, the illustrations preparation subsystem 216, the figure description generating subsystem 218, the patent claims generating subsystem 220, the specification-generating subsystem 222, is configured with the prompt receiving module 230, the data inserting module 232, and the preview interface module 234 (as depicted in FIG. 2B), which collectively enable dynamic user interaction and real-time content manipulation within the patent specification generation process. The prompt receiving module 230, the data inserting module 232, and the preview interface module 234 are configured to function collaboratively to provide a seamless and iterative drafting experience, enhancing both efficiency and quality of the generated patent specification.

The prompt receiving module 230 is configured to accept user input in the form of at least one of: the plurality of prompts and the one or more user defined prompts. The one or more user defined prompts may be entered via one of: a generative AI environment 238 (as depicted in FIG. 2C), which facilitates automated, context-aware generation of patent text based on predefined prompt structures, or a conversational AI environment, which allows the user to interact with the system 102 in a dialogue-driven manner for iterative feedback, clarification, or elaboration. The prompt receiving module 230 is specifically configured to support workflows such as: generating the patent specification according to user defined instructions, regenerating previously generated portions of the patent specification for refinement or clarification, and elaborating specific parts of the patent specification based on additional input, context, or updated invention details.

The data inserting module 232 (as depicted in FIG. 2D) is configured to allow the one or more users to directly insert complex and domain-specific elements into the generated patent specification. The complex and domain-specific elements may include at least one of: the one or more figures (e.g., technical illustrations, schematic diagrams), one or more tables (e.g., comparison tables, performance metrics), one or more special characters (e.g., Greek letters, subscripts), one or more chemical structures (e.g., molecular representations such as SMILES or MOL formats), and one or more mathematical expressions (e.g., equations or formulae). The complex and domain-specific elements may be inserted contextually within the one or more specification sections, including but not limited to, the detailed description section, the one or more claims, or the abstraction section, depending on the disclosure requirements and jurisdictional drafting practices. The data inserting module 232 supports both manual input and intelligent auto-suggestions based on the surrounding text or retrieved chunk data.

The preview interface module 234 is configured to display the generated patent specification in real time within an interactive environment. The preview interface module 234 enables side-by-side or segmented visualization of the generated content as depicted in FIG. 2E, allowing the one or more users to simultaneously access at least one of: a refined invention disclosure workspace 236, a claim generating workspace, and a specification generating workspace. The user interface supports section-wise navigation, enabling the one or more users to review, edit, and traverse through the different parts of the patent specification in a structured manner. The real-time rendering functionality ensures that any updates made via the prompt receiving module 230 or data inserting module 232 are immediately reflected in the preview interface, thus enabling rapid iteration and validation.

Collectively, the prompt receiving module 230, data inserting module 232, and preview interface module 234 ensure that the one or more users are able to interact with the system 102 in a highly responsive, modular, and user-centered environment.

In an exemplary embodiment, the data amendment subsystem 226 is configured to intelligently manage updates and refinements made to the patent specification by receiving one or more user amendments. The one or more user amendments may be made in at least one of: the one or more claims, one specification section of the plurality of specification sections, and one labelled element of the one or more labelled elements. The data amendment subsystem 226 allows the one or more users to introduce revisions or refinements to the generated draft content at any stage of the drafting workflow. The one or more user amendments may include correcting technical inaccuracies, rephrasing language for legal compliance, clarifying ambiguities, or incorporating additional features or embodiments disclosed by the one or more users.

The data amendment subsystem 226 is further configured to detect at least one of: semantic impact and structural impact resulting from the one or more user amendments. The semantic impact refers to changes in meaning or interpretation of claim language or disclosure content, such as modifying a term that may affect claim scope or functional description. The structural impact refers to alterations in logical or hierarchical relationships within the patent document, such as breaking dependencies between the one or more claims, altering antecedent basis, or introducing inconsistencies in the referenced one or more label numbers or the one or more figures.

To determine these impacts, the data amendment subsystem 226 employs techniques including, but not limited to: the dependency parsing procedures, ontology mapping, co-reference resolution, and natural language understanding (NLU) models, and the like. For instance, if a user modifies the description of a component in the detailed description section, the data amendment subsystem 226 evaluates whether that component is also referenced in the one or more claims, the description associated with the one or more figures, or the abstract, and identifies discrepancies that could result in enablement or clarity objections during patent prosecution.

In an exemplary embodiment, the dependency parsing procedures are utilized by the data amendment subsystem 226 to analyze the grammatical structure of the amended text in the one or more claims, one specification section of the plurality of specification sections, and the one or more labelled elements. Dependency parsing identifies the syntactic relationships between words, such as which terms serve as technical subjects, which act as functional predicates, and how modifiers affect the scope of claim elements. This enables the system 102 to determine whether a user amendment alters a technical dependency chain in a way that impacts the meaning, enforceability, or scope of the invention as disclosed in the unamended sections. For example, removing or changing a modifier in a claim might shift the scope from a specific embodiment to a broader class of embodiments, which must be propagated consistently throughout the specification.

The ontology mapping is applied to ensure that amendments remain consistent with the established technical terminology and conceptual relationships defined in the system's internal or domain-specific ontologies. The data amendment subsystem 226 leverages these ontologies, which may include hierarchical classifications of components, processes, chemical structures, or mechanical assemblies, to match amended terms with their standardized equivalents. This ensures that replacing a term, for instance, “sensor element” with “detection module,” is recognized as referring to the same concept, or flagged if it introduces a materially different meaning that may require downstream updates in other parts of the patent specification.

The co-reference resolution is employed to track entities that are referred to in different ways throughout the patent specification and to ensure that amendments do not break these referential links. For example, if a “primary heat exchanger” is referred to as “the exchanger,” “it,” or “the primary unit” elsewhere in the claims or specification, the data amendment subsystem 226 detects these references and ensures they are updated consistently in response to amendments. This prevents discrepancies where different parts of the patent specification may appear to refer to different entities when they are in fact the same, which could otherwise create ambiguity or weaken claim interpretation during examination or litigation.

The NLU models are integrated into the data amendment subsystem 226 to perform semantic-level analysis of amendments. The NLU models assess whether the meaning of a claim or specification section has changed in substance by interpreting the amended language in the context of the entire document, rather than evaluating it solely at the syntactic or lexical level. This allows the data amendment subsystem 226 to detect nuanced changes, such as when an amendment introduces functional limitations, removes a required step, or alters the intended operational sequence in a process claim. The NLU models also simulate how an examiner might interpret the amended language, thereby anticipating whether further changes are necessary to maintain legal and technical consistency across the full patent specification, based on the trained dataset comprising the plurality of examination reports.

The data amendment subsystem 226 is further configured to update corresponding patent specification with the received one or more user amendments in a manner that ensures consistency and traceability across the entire document. This includes maintaining internal consistency of at least: terminology, ensuring uniform usage of defined terms throughout the specification and the one or more claims, scope, preserving the intended breadth or limitations of the invention as amended, and dependencies, updating internal references, cross-links, and claim relationships to align with the amended content.

Additionally, the data amendment subsystem 226 is able to flag potential downstream implications of user edits and optionally provide AI-suggested harmonization or regeneration prompts to maintain overall document coherence. By embedding such real-time amendment intelligence, the data amendment subsystem 226 ensures that any changes made during late-stage patent specification generation or pre-filing review do not inadvertently compromise the legal strength, structural integrity, or technical clarity of the complete patent specification.

The data amendment subsystem 226 is configured to execute changes, modifications, amendments, or additions in the corresponding sections of the patent specification if the one or more sections, or one or more lines within a particular specification section, of the patent specification are amended in real-time or at a later stage. For instance, if all sections of the patent specification are generated and subsequently the user amends the preamble of a claim, the data amendment subsystem 226 will, in response to this input, review and amend the title, abstract, the field of invention, the summary of the invention, the independent claim(s), and the corresponding dependent claims accordingly.

In an exemplary embodiment, if new information is added to the one or more claims, such as a new group of solvents that could be used alternatively in the context of the given invention, the data amendment subsystem 226 will, in response to this input, review the dependent claims, and add the necessary explanations for enablement of the new group of solvents at a location corresponding to the said claim in the detailed description section. The review the dependent claims may include addition or modification or renumbering of the dependent claims, Additionally, the summary and other sections of the specification of the patent application will be amended if the addition indicates an alternative embodiment.

In an exemplary embodiment, the specification orchestrating subsystem 224 is configured to orchestrate the specification responses and the one or more claims in a user-selected jurisdiction template within the one or more jurisdiction templates. This orchestration is based on at least one of: jurisdiction-specific legal formatting rules, section ordering protocols, phrasing requirements, and specification section mappings for generating the patent specification. The specification orchestrating subsystem 224 operates as a post-processing and assembly layer, ensuring that each generated specification response and the one or more claims are accurately placed within the correct section of the selected jurisdiction template. The jurisdiction-specific legal formatting rules may include, but are not limited to, margin settings, font requirements, paragraph numbering conventions, mandatory section titles, and claim numbering styles as prescribed by the respective patent office. The section ordering protocols define the mandatory sequence in which the specification sections are arranged, such as placing the technical field before the background or ensuring the one or more claims appear after the detailed description, depending on jurisdictional practice. The phrasing requirements ensure that the language used in each section adheres to prescribed norms, such as avoiding relative terminology without reference points, limiting the use of “means for” language where restricted, and ensuring antecedent basis consistency between the one or more claims and the specification. The specification section mappings enable automated correlation between generated outputs (e.g., the description associated with the one or more figures, claim bodies, and background text) and their respective positions in the jurisdiction template, ensuring structural coherence and legal compliance. The specification orchestrating subsystem 224 may further validate that all mandatory sections are present and in proper sequence, and that any jurisdiction-specific disclaimers, statement formats, or cross-reference requirements are incorporated before finalizing the complete patent specification for submission.

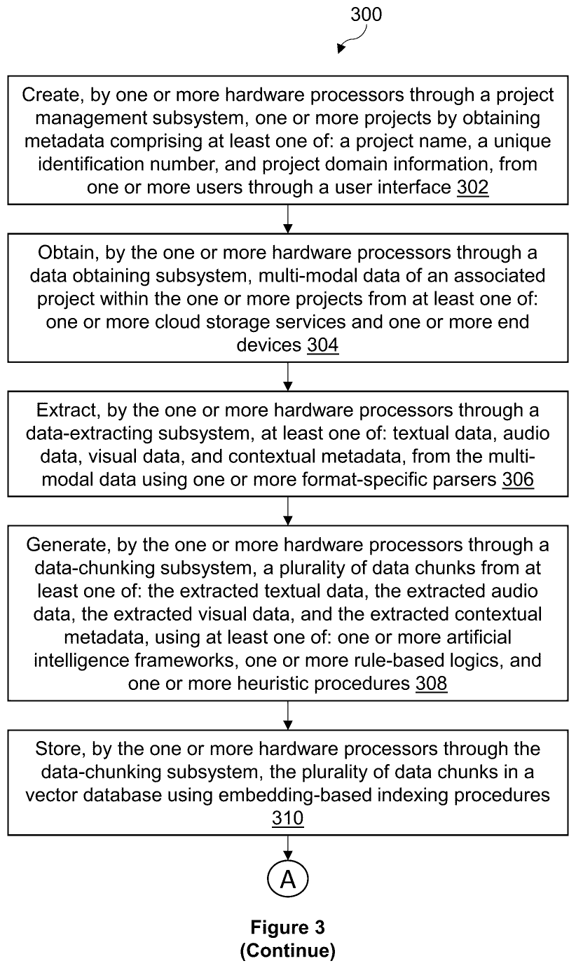

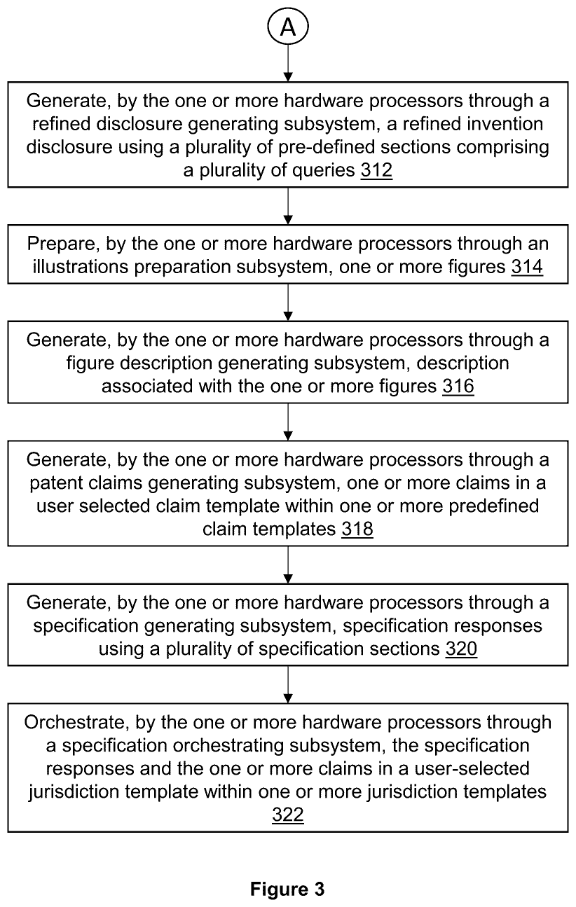

FIG. 3 illustrates an exemplary flow chart of an artificial intelligence-based method 300 for generating the patent specification, in accordance with an embodiment of the present disclosure.

In accordance with another embodiment of the present disclosure, the artificial intelligence-based method 300 for generating the patent specification is disclosed. At step 302, the artificial intelligence-based method 300 includes creating, by the one or more hardware processors 110 through the project management subsystem 206, the one or more projects by obtaining the metadata comprising at least one of: the project name, the unique identification number, and the project domain information, from the one or more users through the user interface. The one or more computer-implemented tools comprise at least one of: the project creation tool, the docketing tool, the document management tool, the timeline management tool, and the jurisdiction selection tool. The project management subsystem 206 is configured to select at least one domain-specific generative artificial intelligence agent from the plurality of domain-specific generative artificial intelligence agents based on the project domain information.

At step 304, the artificial intelligence-based method 300 includes obtaining, by the one or more hardware processors 110 through the data obtaining subsystem 208, the multi-modal data of the associated project within the one or more projects from at least one of: the one or more cloud storage services and the one or more end devices 106. The multi-modal data comprises at least one of, but not limited to, the invention disclosures, the non-patent literatures, the presentation decks, the design prototypes, the test results, the performance logs, the illustration sketches, the chemical structure representations, the biological sequence data, the formulation datasets, the prior art references, and the like. The multi-modal data is provided in at least one of, but not limited to, the textual formats, the image-based formats, the audio formats, the video formats, the SDF formats, the presentation formats, the MOL file format, the SMILES formats, and the InChl formats.

At step 306, the artificial intelligence-based method 300 includes extracting, by the one or more hardware processors 110 through the data-extracting subsystem 210, at least one of: the textual data, the audio data, the visual data, and the contextual metadata, from the multi-modal data using the one or more format-specific parsers. The one or more format-specific parsers comprise at least one of, but not limited to, the one or more natural language parsers, the one or more OCR parsers, the one or more audio-to-text transcription modules, the one or more image parsers, the one or more chemical structure parsers, the one or more video parsers, the one or more metadata extractors, the one or more domain-specific structured data parsers, and the like. Optionally, at step 306, normalization of at least one of: the textual data, the audio data, the visual data, and the contextual metadata, is performed by at least one of: strip out boilerplate language, disclaimers, eliminate scanned watermark overlays, and fix encoding issues.

At step 308, the artificial intelligence-based method 300 includes generating, by the one or more hardware processors 110 through the data-chunking subsystem 212, the plurality of data chunks from at least one of: the extracted textual data, the extracted audio data, the extracted visual data, and the extracted contextual metadata, using at least one of: the one or more artificial intelligence frameworks, the one or more rule-based logics, and the one or more heuristic procedures.

At step 310, the artificial intelligence-based method 300 includes storing, by the one or more hardware processors 110 through the data-chunking subsystem 212, the plurality of data chunks in the vector database using the embedding-based indexing procedures.

At step 312, the artificial intelligence-based method 300 includes generating, by the one or more hardware processors 110 through the refined disclosure generating subsystem 214, the refined invention disclosure using the plurality of pre-defined sections comprising the plurality of queries, each query of the plurality of queries characterizes as the plurality of prompts for the one or more artificial intelligence models to generate the fine-tuned response by retrieving applicable data chunks of the plurality of data chunks from the vector database. Further, at step 312, generating, by the one or more hardware processors 110 through the refined disclosure generating subsystem 214, the one or more clarifying queries based on detected indistinctness in at least one of: the multi-modal data, the plurality of data chunks, and the fine-tuned response associated with each query of the plurality of queries. The refined disclosure generating subsystem 214 is configured to generate the fine-tuned response to each clarifying query of the one or more clarifying queries by processing the applicable data chunks within the plurality of data chunks using at least one of: the TRIZ principles, the semantic similarity procedures, the contextual co-occurrence procedures, and the dependency mapping procedures. Furthermore, the refined disclosure generating subsystem 214 is configured to compile the plurality of queries and the one or more clarifying queries with the associated fine-tuned responses into the structured disclosure output as the refined invention disclosure.

At step 314, the artificial intelligence-based method 300 includes preparing, by the one or more hardware processors 110 through the illustrations preparation subsystem 216, the one or more figures by at least one of: extracting the one or more figures from the multi-modal data, obtaining prepared illustration data from at least one of: the one or more cloud storage services and the one or more end devices 106, generating the one or more figures based on the refined invention disclosure, and providing the figure-editor tool for generating the one or more figures. The illustrations preparation subsystem 216 is configured with the one or more OCR parsers to extract the one or more figures from the multi-modal data. The illustrations preparation subsystem 216 further comprises the generative image model configured to convert the one or more figures in one of: the hand drawn figures, the photographic figures, and the CAD-based 3d figures into line drawings conforming to jurisdictional guidelines for format of the one or more figures.

At step 316, the artificial intelligence-based method 300 includes generating, by the one or more hardware processors 110 through the figure description generating subsystem 218, the description associated with the one or more figures by mapping at least one of: the plurality of data chunks and the refined invention disclosure, with at least one of: one or more label numbers and one or more label names, extracted from each figure of the one or more figures. The figure description generating subsystem 218 is configured to perform one of: optical extraction and semantic extraction of at least one of: the one or more label numbers and the one or more label names from each figure of the one or more figures using at least one of: the one or more image recognition models and the natural language processing models. The figure description generating subsystem 218 is configured to contextually map the one or more label names with the corresponding one or more labelled elements in the refined invention disclosure and the plurality of data chunks by using at least one of: the relation extraction models, the visual-textual alignment models, the embedding similarity computation procedures, and the NER procedures. The figure description generating subsystem 218 is configured to generate the description associated with the one or more figures comprising at least one of: the structural identification, the functional role, the spatial relationship, and the interconnection of the one or more labelled elements.

At step 318, the artificial intelligence-based method 300 includes generating, by the one or more hardware processors 110 through the patent claims generating subsystem 220, one or more claims in the user selected claim template within the one or more predefined claim templates. This is done by analyzing at least one of: the one or more prior art data chunks in the plurality of data chunks, the description associated with the one or more figures, and the refined invention disclosure, using at least one of: the one or more artificial intelligence models and the one or more user-defined prompts.

At step 320, the artificial intelligence-based method 300 includes generating, by the one or more hardware processors 110 through the specification-generating subsystem 222, specification responses using the plurality of specification sections. The plurality of specification sections characterizes as the plurality of prompts for the one or more artificial intelligence models to generate the specification responses by retrieving information from at least one of: the applicable data chunks from the plurality of data chunks, the refined invention disclosure, the description associated with the one or more figures, and the generated one or more claims, using at least one of: the NER procedures, the relation extraction procedures, the dependency parsing procedures, and the action mapping procedures. The plurality of specification sections comprising at least one of: the title section, the cross-references section, the technical field section, the background section, the objectives of the invention section, the summary of the invention section, the brief description of the drawings, the detailed description section, the abstract, and the one or more optional jurisdiction-defined sections.

At step 322, the artificial intelligence-based method 300 includes orchestrating, by the one or more hardware processors 110 through the specification orchestrating subsystem 224, the specification responses and the one or more claims in the user-selected jurisdiction template within the one or more jurisdiction templates. This orchestration is performed based on at least one of: the jurisdiction-specific legal formatting rules, the section ordering protocols, the phrasing requirements, and the specification section mappings, to generate the patent specification.

Numerous advantages of the present disclosure may be apparent from the discussion above. In accordance with the present disclosure, the system 102 for generating the patent specification automates the drafting, editing, and management of the patent specification. The system 102 automates and enhance various aspects of the patent specification generation process. By providing the interactive user interface for thorough review, including checklists and validation mechanisms, the system 102 facilitates the one or more users to produce clear, precise, and well-structured patent documents. Additionally, the integration of examination report analysis enables the system 102 to continuous improvement of pre-defined instructions, reducing the likelihood of common drafting errors and improving the overall quality and compliance of patent applications.

The system 102 is configured to autonomously process heterogeneous multi-modal data, including the textual formats, the audio formats, the visual formats, the chemical structure representations, and the biological sequence data, through the integrated sequence of specialized subsystems. Unlike conventional approaches that rely heavily on manual drafting and fragmented tools, the present system 102 leverages vector database-driven chunk retrieval, semantic similarity models, and the plurality of domain-specific generative AI agents to ensure contextual accuracy, internal consistency, and jurisdiction-specific compliance across the entire patent specification. This results in a significant reduction in drafting time, enhanced precision in aligning claims with supporting disclosure, and dynamic adaptability to user-provided amendments without compromising structural integrity or legal sufficiency. Furthermore, the modular architecture enables scalable deployment across servers, cloud platforms, and end devices, thereby offering real-time, interactive patent preparation capabilities that are not achievable with existing static or semi-automated solutions.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

What is claimed is:

1. An artificial intelligence-based system for generating a patent specification, comprising:
one or more hardware processors; and
a memory unit operatively connected to the one or more hardware processors, wherein the memory unit comprises a set of computer-readable instructions in form of a plurality of subsystems, configured to be executed by the one or more hardware processors, wherein the plurality of subsystems comprises:
a project management subsystem configured with one or more computer-implemented tools to create one or more projects by obtaining metadata comprising at least one of: a project name, a unique identification number, and project domain information, from one or more users through a user interface;
a data obtaining subsystem configured to obtain multi-modal data of an associated project within the one or more projects from at least one of: one or more cloud storage services and one or more end devices;
a data-extracting subsystem configured to extract at least one of: textual data, audio data, visual data, and contextual metadata, from the multi-modal data using one or more format-specific parsers;
a data-chunking subsystem configured to:
generate a plurality of data chunks from at least one of: the extracted textual data, the extracted audio data, the extracted visual data, and the extracted contextual metadata, using at least one of: one or more artificial intelligence frameworks, one or more rule-based logics, one or more heuristic procedures; and
store the plurality of data chunks in a vector database using embedding-based indexing procedures;
a refined disclosure generating subsystem configured with a plurality of pre-defined sections comprising a plurality of queries,
wherein each query of the plurality of queries characterizes as a plurality of prompts for one or more artificial intelligence models to generate a fine-tuned response, by retrieving applicable data chunks within the plurality of data chunks from the vector database for generating a refined invention disclosure;
an illustrations preparation subsystem configured to at least one of: extract one or more figures from the multi-modal data, obtain prepared illustration data from at least one of: the one or more cloud storage services and the one or more end devices, generate the one or more figures based on the refined invention disclosure, and provide a figure-editor tool for generating the one or more figures;
a figure description generating subsystem configured to generate description associated with the one or more figures by mapping at least one of: the plurality of data chunks and the refined invention disclosure, with at least one of: one or more label numbers and one or more label names, extracted from each figure of the one or more figures;
a patent claims generating subsystem configured to generate one or more claims in a user selected claim templet within one or more predefined claim templates, based on analyzing at least one of: one or more prior art data chunks in the plurality of data chunks, the description associated with the one or more figures, and the refined invention disclosure, using at least one of: the one or more artificial intelligence models and one or more user defined prompts;
a specification-generating subsystem configured with a plurality of specification sections,
wherein the plurality of specification sections characterizes as the plurality of prompts for the one or more artificial intelligence models to generate specification responses, by retrieving information at least one of: the applicable data chunks from the plurality of data chunks, the refined invention disclosure, the description associated with the one or more figures, and the generated one or more claims, using at least one of: named entity recognition (NER) procedures, relation extraction procedures, dependency parsing procedures, and action mapping procedures; and
a specification orchestrating subsystem configured to orchestrate the specification responses and the one or more claims in a user-selected jurisdiction template within the one or more jurisdiction templates based on at least one of:
jurisdiction-specific legal formatting rules, section ordering protocols, phrasing requirements, and specification section mappings for generating the patent specification.

2. The artificial intelligence-based system of claim 1, wherein at least one of: the refined disclosure generating subsystem, the illustrations preparation subsystem, the figure description generating subsystem, the patent claims generating subsystem, and the specification generating subsystem, are configured with a prompt receiving module, a data inserting module, and a preview interface module,
the prompt receiving module is configured to receive at least one of: the plurality of prompts and the one or more user defined prompts, in at least one of: a generative artificial intelligence environment, and a conversation artificial intelligence environment, for one of: generating the patent specification in user defined instructions, regenerating the generated patent specification, and elaborating the generated patent specification;
the data inserting module is configured to allow the one or more users to insert at least one of: the one or more figures, one or more tables, one or more special characters, one or more chemical structures, and one or more mathematical expressions, in the patent specification; and
the preview interface module is configured to display the generated patent specification in real time alongside at least one of: a refined invention disclosure workspace, a claim generating workspace, and a specification generating workspace, to provide section-wise navigation for reviewing the generated patent specification.

3. The artificial intelligence-based system of claim 1, wherein the one or more computer-implemented tools comprise at least one of: a project creation tool, a docketing tool, a document management tool, a timeline management tool, and a jurisdiction selection tool.

4. The artificial intelligence-based system of claim 1, wherein the project management subsystem is configured to select at least one domain-specific generative artificial intelligence agent from a plurality of domain-specific generative artificial intelligence agents based on the project domain information,
the plurality of domain-specific generative artificial intelligence agents trained on at least one of: historical patent documents, a plurality of examination reports, historical technical literatures, historical standards documents, historical product manuals, and historical scholarly publications, associated with a corresponding technical domain; and
the plurality of domain-specific generative artificial intelligence agents fine-tuned on at least one of: diverse disclosure styles, terminologies, and structural conventions unique to diverse domains.

5. The artificial intelligence-based system of claim 1, wherein the multi-modal data comprises at least one of: invention disclosures, non-patent literatures, presentation decks, design prototypes, test results, performance logs, illustration sketches, chemical structure representations, biological sequence data, formulation datasets, and prior art references; and
the multi-modal data is provided in at least one of: textual formats, image-based formats, audio formats, video formats, structured data file (SDF) formats, presentation formats, molecular (MOL) file format, simplified molecular input line entry system (SMILES) formats, and international chemical identifier (InChl) formats.

6. The artificial intelligence-based system of claim 1, wherein the data-extracting subsystem further configured to at least one of:
detect each file in the multi-modal data based on at least one of: file extensions, multipurpose internet mail extensions (MIME type), and content-based sniffing;
route each file in the multi-modal data to an associated format-specific parser within the one or more format-specific parsers to extract raw information;
extract at least one of: the textual data, the audio data, the visual data, and the contextual metadata, associated with the raw information using the one or more format-specific parsers,
the one or more format-specific parsers comprise at least one of: one or more natural language parsers, one or more optical character recognition (OCR) parsers, one or more audio-to-text transcription modules, one or more image parsers, one or more chemical structure parsers, one or more video parsers, one or more metadata extractors, and one or more domain-specific structured data parsers; and
normalize at least one of: the textual data, the audio data, the visual data, and the contextual metadata, by at least one of: strip out boilerplate language, disclaimers, eliminate scanned watermark overlays, and fix encoding issues.

7. The artificial intelligence-based system of claim 1, wherein the refined disclosure generating subsystem further configured to at least one of:
provide one or more clickable elements to generate the plurality of queries to add to the refined invention disclosure;
provide the fine-tuned response to each query of the plurality of queries using the one or more artificial intelligence models by retrieving the applicable data chunks;
generate one or more clarifying queries based on detected indistinctness in at least one of: the multi-modal data, the plurality of data chunks, and the fine-tuned response associated with each query of the plurality of queries;
generate the fine-tuned response to each clarifying query of the one or more clarifying queries by processing the applicable data chunks within the plurality of data chunks using at least one of: Teoriya Resheniya Izobretatelskikh Zadatch (TRIZ) principles, semantic similarity procedures, contextual co-occurrence procedures, and dependency mapping procedures; and
compile the plurality of queries and the one or more clarifying queries with associated fine-tuned responses into a structured disclosure output as the refined invention disclosure.

8. The artificial intelligence-based system of claim 1, wherein the illustrations preparation subsystem is configured with the one or more optical character recognition (OCR) parsers to extract the one or more figures from the multi-modal data.

9. The artificial intelligence-based system of claim 1, wherein the illustrations preparation subsystem further comprises a generative image model configured to convert the one or more figures in one of: hand drawn figures, photographic figures, and computer-aided design (CAD)-based three-dimensional figures into line drawings conforming to jurisdictional guidelines for format of the one or more figures.

10. The artificial intelligence-based system of claim 1, wherein the figure description generating subsystem is configured to:
perform one of: optical extraction and semantic extraction of at least one of: the one or more label numbers and the one or more label names from each figure of the one or more figures using at least one of: one or more image recognition models and natural language processing models;
contextually map the one or more label names with corresponding one or more labelled elements in the refined invention disclosure and the plurality of data chunks by using at least one of: relation extraction models, visual-textual alignment models, embedding similarity computation procedures, and the named entity recognition (NER) procedures; and
generate the description associated with the one or more figures comprising at least one of: structural identification, functional role, spatial relationship, and interconnection of the one or more labelled elements.

11. The artificial intelligence-based system of claim 1, wherein the patent claims generating subsystem configured to:
classify the user-selected claim template as one of: a method claim, a system claim, a product claim, and a process claim;
extract claimable subject matter from at least one of: the refined invention disclosure, the figure description, and the one or more prior art data chunks, using the one or more artificial intelligence models comprising at least one of:
one or more natural language processing models for semantic parsing;
one or more comparative analysis models to distinguish novel features from the one or more prior art data chunks;
dependency parsing to determine logical relationships between technical features in the plurality of data chunks; and
a rule-based claims logic prompts for constructing preamble, transitional phrases, and body elements;
generate the one or more claims comprising: an independent claim and one or more dependent claims; and
validate the one or more claims against predefined jurisdiction-specific claim drafting rules, including at least one of: number of claims, unity of an invention, and dependency constraints.

12. The artificial intelligence-based system of claim 1, wherein the plurality of specification sections comprising at least one of: a title section, a cross-references section, a technical field section, a background section, objectives of the invention section, a summary of the invention section, a brief description of the drawings, a detailed description section, an abstract, and one or more optional jurisdiction-defined sections.

13. The artificial intelligence-based system of claim 1, wherein the specification generating subsystem is configured to maintain internal consistency across the plurality of specification sections by validating that each claim of the one or more claims is supported in the generated specification responses, and each figure of the one or more figures is aligned with the description associated with the one or more figures and related specification sections.

14. The artificial intelligence-based system of claim 1, wherein the patent claims generating subsystem and the specification generating subsystem are configured with the plurality of domain-specific generative artificial intelligence agents,
the plurality of domain-specific generative artificial intelligence agents are trained on the plurality of examination reports using supervised learning procedures, configured to:
adapt claim phrasing, claim structure, claim dependency relationships, and generate the specification responses for the plurality of specification sections, based on frequently encountered objections in the plurality of examination reports.

15. The artificial intelligence-based system of claim 1, wherein the specification generating subsystem further comprises a specification validation module,
the specification validation module is configured to analyze each specification section of the plurality of specification sections with the generated specification responses to check compliance and consistency with at least one of: terminology associated with the one or more claims, formatting rules, language guidelines, and enablement requirements; and
the specification validation module is configured to analyze each specification section of the plurality of specification sections based on the jurisdictional guidelines, using at least one of: the named entity recognition (NER) procedures, a jurisdiction rules validator configured with regex patterns, one or more large language models (LLMs) trained on legal drafting datasets.

16. The artificial intelligence-based system of claim 1, wherein the plurality of subsystems further comprises: a data amendment subsystem,
the data amendment subsystem is configured to:
receive one or more user amendments made in at least one: the one or more claims, one specification section of the plurality of specification sections, and one labelled element of the one or more labelled elements;
detect at least one of: semantic impact and structural impact of the one or more user amendments on at least one of: unamended claims of the one or more claims, unamended specification section of the plurality of specification sections within the patent specification; and
update corresponding patent specification with the received one or more user amendments based on detected at least one of: the semantic impact and the structural impact to maintain internal consistency of terminology, scope, and dependencies.

17. An artificial intelligence-based method for generating a patent specification, comprising:
creating, by one or more hardware processors through a project management subsystem, one or more projects by obtaining metadata comprising at least one of: a project name, a unique identification number, and project domain information, from one or more users through a user interface;
obtaining, by the one or more hardware processors through a data obtaining subsystem, multi-modal data of an associated project within the one or more projects from at least one of: one or more cloud storage services and one or more end devices;
extracting, by the one or more hardware processors through a data-extracting subsystem, at least one of: textual data, audio data, visual data, and contextual metadata, from the multi-modal data using one or more format-specific parsers;
generating, by the one or more hardware processors through a data-chunking subsystem, a plurality of data chunks from at least one of: the extracted textual data, the extracted audio data, the extracted visual data, and the extracted contextual metadata, using at least one of: one or more artificial intelligence frameworks, one or more rule-based logics, and one or more heuristic procedures;
storing, by the one or more hardware processors through the data-chunking subsystem, the plurality of data chunks in a vector database using embedding-based indexing procedures;
generating, by the one or more hardware processors through a refined disclosure generating subsystem, a refined invention disclosure using a plurality of pre-defined sections comprising a plurality of queries, wherein each query of the plurality of queries characterizes as a plurality of prompts for one or more artificial intelligence models to generate a fine-tuned response by retrieving applicable data chunks of the plurality of data chunks from the vector database;
preparing, by the one or more hardware processors through an illustrations preparation subsystem, one or more figures by at least one of: extracting the one or more figures from the multi-modal data, obtaining prepared illustration data from at least one of: the one or more cloud storage services and the one or more end devices, generating the one or more figures based on the refined invention disclosure, and providing a figure-editor tool for generating the one or more figures;
generating, by the one or more hardware processors through a figure description generating subsystem, description associated with the one or more figures by mapping at least one of: the plurality of data chunks and the refined invention disclosure, with at least one of: one or more label numbers and one or more label names, extracted from each figure of the one or more figures;
generating, by the one or more hardware processors through a patent claims generating subsystem, one or more claims in a user selected claim template within one or more predefined claim templates, based on analyzing at least one of: one or more prior art data chunks in the plurality of data chunks, the description associated with the one or more figures, and the refined invention disclosure, using at least one of: the one or more artificial intelligence models and one or more user defined prompts;
generating, by the one or more hardware processors through a specification generating subsystem, specification responses using a plurality of specification sections, wherein the plurality of specification sections characterizes as the plurality of prompts for the one or more artificial intelligence models to generate the specification responses by retrieving information from at least one of: the applicable data chunks from the plurality of data chunks, the refined invention disclosure, the description associated with the one or more figures, and the generated one or more claims, using at least one of: named entity recognition (NER) procedures, relation extraction procedures, dependency parsing procedures, and action mapping procedures; and
orchestrating, by the one or more hardware processors through a specification orchestrating subsystem, the specification responses and the one or more claims in a user-selected jurisdiction template within one or more jurisdiction templates based on at least one of: jurisdiction-specific legal formatting rules, section ordering protocols, phrasing requirements, and specification section mappings to generate the patent specification.

18. The artificial intelligence-based method of claim 17, further comprising:
receiving, by the one or more hardware processors through a prompt receiving module, at least one of: the plurality of prompts and the one or more user defined prompts, in at least one of: a generative artificial intelligence environment, and a conversation artificial intelligence environment, to one of: generate the patent specification in user defined instructions, regenerate the generated patent specification, and elaborate the generated patent specification;
allowing, by the one or more hardware processors through data inserting module, a user to insert at least one of: the one or more figures, one or more tables, one or more special characters, one or more chemical structures, and one or more mathematical expressions, in the patent specification; and
displaying, by the one or more hardware processors through a preview interface module, the generated patent specification in real time alongside at least one of: a refined invention disclosure workspace, a claim generating workspace, and a specification generating workspace, to provide section-wise navigation to review the generated patent specification.

19. The artificial intelligence-based method of claim 17, further comprising:
configuring the patent claims generating subsystem and the specification generating subsystem with a plurality of domain-specific generative artificial intelligence agents;
training the plurality of domain-specific generative artificial intelligence agents on a plurality of examination reports using supervised learning procedures;
adapting claim phrasing, claim structure, and claim dependency relationships based on frequently encountered objections in the plurality of examination reports; and
generating specification responses for a plurality of specification sections based on the frequently encountered objections in the plurality of examination reports.

20. The artificial intelligence-based method of claim 17, further comprising:
receiving, by a data amendment subsystem, one or more user amendments made in at least one: the one or more claims, one specification section of the plurality of specification sections, and one labelled element of the one or more labelled elements;
detecting, by the data amendment subsystem, at least one of: semantic impact and structural impact of the one or more user amendments on at least one of: unamended claims of the one or more claims, unamended specification section of the plurality of specification sections within the patent specification;
updating, by the data amendment subsystem, corresponding patent specification with the received one or more user amendments based on detected at least one of: the semantic impact and the structural impact to maintain internal consistency of terminology, scope, and dependencies.
